(19) United States
(12) Patent Application Publication
(10) Pub. No.: US 2015/0147681 A1
(43) Pub. Date: May 28, 2015

(54) Palladium-Based Catalysts for Fuels Electrooxidation Prepared by Sacrificial Support Method

(71) Applicants: Alexey Serov, Albuquerque, NM (US); Plamen B. Atanassov, Santa Fe, NM (US)

(72) Inventors: Alexey Serov, Albuquerque, NM (US); Plamen B. Atanassov, Santa Fe, NM (US)

(73) Assignee: STC.UNM, Albuquerque, NM (US)

(21) Appl. No.: 14/504,718

(22) Filed: Oct. 2, 2014

Related U.S. Application Data
(60) Provisional application No. 61/885,612, filed on Oct. 2, 2013.

(51) Int. Cl. H01M 4/92; H01M 4/88

(52) U.S. Cl. CPC H01M 4/921; H01M 4/8842; H01M 4/928
USPC 429/524; 502/300; 502/339; 502/331; 429/523; 429/525

(57) ABSTRACT

A self-supporting porous alloyed metal material and methods for forming the same. The method utilizes a sacrificial support based technique that enables the formation of uniquely shaped voids in the material. The material is suitable for use as an electrocatalyst in a variety of fuel cell and other applications.

### CROSS-REFERENCE TO RELATED APPLICATIONS

The following application claims benefit of U.S. Provisional Application No. 61/885,612, filed Oct. 2, 2013, which is hereby incorporated by reference in its entirety.

### BACKGROUND

Fuel cells are receiving increasing attention as a viable energy-alternative. In general, fuel cells convert electrochemical energy into electrical energy in an environmentally clean and efficient manner. Fuel cells are contemplated as potential energy sources for everything from small electronics to cars and homes. In order to meet different energy requirements, there are a number of different types of fuel cells in existence today, each with varying chemistries, requirements, and uses.

Direct Liquid Fed Fuel cells (DLFFCs) including, for example, Direct Alcohol Fuel Cells (DAFCs), have attracted more and more interest in the recent years as alternative to hydrogen fed fuel cells. Alcohols are liquids and therefore they have high volumetric and gravimetric energy densities, their storage is easy and their distribution doesn't need new infrastructures. Alcohols have been considered as promising fuels for several fuel cell types with applications in both mobile and back-up devices. Taking into account that several alcohols are side products of bio-mass conversion, they can be valuable alternatives to hydrogen fuels. For example, glycerol has been proposed as a convenient fuel because it has a bio-renewable character, and this compound is a non-valued by-product of the bio-fuel industry. However, for energy production the complete oxidation of glycerol into CO₂ requires the breaking of the C—C bonds, which is rather difficult to perform at the low working temperatures of DAFCs and the glycerol oxidation reaction produces a large number of reaction products. Though, it has been proposed that all C₃ oxidized species from glycerol are valuable fine chemicals.

Most alcohol electro-oxidation studies have been performed in acidic media. The majority of anode electro-catalysts developed for DAFCs utilize a proton exchange membrane (namely Nafion®) and platinum based catalysts. At the moment such systems have lower performance and durability compared to hydrogen PEMFCs due to fuel cross-over, slow kinetics of alcohol electrooxidation, and low stability of catalyst layers. A significant drawback of these devices is the high price associated with platinum and platinum-based catalysts used for both anodic and cathodic reactions, preventing successful commercialization.

Accordingly, novel systems for DLFFCs that utilize non-platinum-based catalysts that achieve greater performance, durability, and cost-effectiveness than those currently achieved with proton exchange membranes and platinum-based catalysts are greatly desired.

### SUMMARY

According to various embodiments the present disclosure provides novel materials that are capable of oxidation and conversion of water-soluble carbon-containing and non-carbon containing fuels and novel methods for making the same. According to various embodiments, such materials are suitable for use as catalysts in DLFFCs including in DLFFCs that utilize alcohols-based fuels (DAFCs), among other applications. According to various embodiments, these materials are molecular alloys of at least two metals which, when formed as an alloy, synergistically increase the oxidative and conversion properties of the alloy above the levels produced by either metal alone. According to still further embodiments, at least one of the metals is palladium.

According to still further embodiments, the present disclosure provides methods for making the above-mentioned materials. The method includes the use of a sacrificial support (also referred to herein as a sacrificial template) particles. The metal alloy is formed around the sacrificial support particles, which is then removed, producing a self-supporting porous material comprising a plurality of voids where the sacrificial support particles had once resided.

### BRIEF DESCRIPTION OF THE DRAWINGS

FIG. 1 is an SEM of a self-supported Pd₄Bi₁ sample.

FIG. 2 is an SEM of the self-supported Pd₄Bi₁ sample of FIG. 1 at higher resolution.

FIG. 3 is a TEM micrograph of a self-supported Pd₄Bi₁ sample.

FIG. 4 is another TEM micrograph of a self-supported Pd₆Bi₁ sample.

FIG. 5 is a Cyclic voltammogram of Pd and Pd₆Bi₁ self-supported catalysts recorded in 0.1 M KOH N₂-saturated electrolyte (v=0.020 V s⁻¹; T=25° C.).

FIG. 6 is a cyclic voltammogram of PdₓBi self-supported catalysts recorded in 0.1 M KOH N₂-saturated electrolyte (v=0.020 V s⁻¹; T=25° C.).

FIG. 7a-7f presents detailed XPS core level spectra of Pd 3d and Bi 4f orbitals on synthesized catalysts (a,b) Pd₆Bi₁; (c,d) Pd₄Bi₁; (e,f) Pd₂Bi₁.

FIG. 8 is a polarization curve recorded for the oxidation of 0.1 M Glycerol in 1M KOH electrolyte on self-supported PdₓBi catalysts (scan rate 0.020 V s⁻¹, T=25° C.).

FIG. 9 is another polarization curve recorded for the oxidation of 0.1 M Glycerol in 1M KOH electrolyte on self-supported PdₓBi catalysts (scan rate 0.020 V s⁻¹, T=25° C.).

FIG. 10 is chronoamperometry recorded for the glycerol electro-oxidation on a self-supported Pd and PdₓBi catalysts at 0.6 V vs. RHE in 1M KOH+0.1M glycerol solution (T=25° C.).

FIG. 11 is chronoamperometry recorded for the glycerol electro-oxidation on a self-supported Pd and PdₓBi catalysts at 0.7 V vs. RHE in 1M KOH+0.1M glycerol solution (T=25° C.).

FIG. 12 shows In situ FTIR spectra recorded for the glycerol electrooxidation on a self-supported Pd₄Bi₁ catalyst rom 0.6 V vs. RHE to 1.2 V vs. RHE and to 0.6 V vs. RHE in 1M KOH+0.1M glycerol solution (scan rate 0.001 V s-1, T=25° C.).

FIG. 13 shows XRD data for Pd—Cu catalysts: A) Pd₃Cu, B) PdCu, and C) PdCu₃ prepared by thermal treatment of metal nitrates in a H₂ atmosphere.

FIG. 14 is an SEM image of PdCu₃ prepared as described herein.

FIG. 15 is an SEM image of PdCu prepared as described herein.

FIG. 16 is an SEM image of PD₃Cu prepared as described herein.

FIG. 17 is a TEM image of PdCu₃ prepared as described herein.

FIG. 18 is a TEM image of PdCu prepared as described herein.

FIG. 19 is a TEM image of Pd₃Cu prepared as described herein.

FIG. 20 is a cyclic voltammogram of MeOH electrooxidation by different Pd—Cu catalysts: PdCu₃ (-), PdCu (- - -), Pd₃Cu (• • •) and Pd (- • -). Conditions: 1M KOH+1M MeOH/EtOH (0.1 M EG/glycerol), catalyst loading −200 μg cm⁻², 1600 RPM, 20 mV s⁻¹.

FIG. 21 is a cyclic voltammogram of EtOH electrooxidation by different Pd—Cu catalysts: PdCu₃ (-), PdCu (- - -), Pd₃Cu (• • •) and Pd (- • -). Conditions: 1M KOH+1M MeOH/EtOH (0.1 M EG/glycerol), catalyst loading −200 μg cm⁻², 1600 RPM, 20 mV s⁻¹.

FIG. 22 is a cyclic voltammogram of EG electrooxidation by different Pd—Cu catalysts: PdCu₃ (-), PdCu (- - -), Pd₃Cu (• • •) and Pd (- • -). Conditions: 1M KOH+1M MeOH/EtOH (0.1 M EG/glycerol), catalyst loading −200 μg cm⁻², 1600 RPM, 20 mV s⁻¹.

FIG. 23 is a cyclic voltammogram of glycerol electrooxidation by different Pd—Cu catalysts: PdCu₃ (-), PdCu (- - -), Pd₃Cu (• • •) and Pd (- •-). Conditions: 1M KOH+1M MeOH/EtOH (0.1 M EG/glycerol), catalyst loading −200 μg cm⁻², 1600 RPM, 20 mV s⁻¹.catalysts.

FIG. 24 is a depiction of the first of the two most stable adsorption structures of EtOH on Pd(111) and Pd₃Cu(111) surfaces as calculated using Density Functional Theory.

FIG. 25 is a depiction of the second of the two most stable adsorption structures of EtOH on Pd(111) and Pd₃Cu(111) surfaces as calculated using Density Functional Theory.

FIG. 26 is a depiction of a first of the two most stable adsorption structures of OH on Pd(111) and Pd₃Cu(111) surfaces as calculated using Density Functional.

FIG. 27 is a depiction of a second of the two most stable adsorption structures of OH on Pd(111) and Pd₃Cu(111) surfaces as calculated using Density Functional Theory.

FIG. 28 shows In situ IRRAS of MeOH electrooxidation on Pd₃Cu. Conditions: 0.1 M KOH+1 M MeOH/EtOH (0.1 M EG/glycerol), V vs. RHE.

FIG. 29 shows In situ IRRAS of EtOH electrooxidation on Pd₃Cu. Conditions: 0.1 M KOH+1 M MeOH/EtOH (0.1 M EG/glycerol), V vs. RHE.

FIG. 30 shows In situ IRRAS of EG electrooxidation on Pd₃Cu. Conditions: 0.1 M KOH+1 M MeOH/EtOH (0.1 M EG/glycerol), V vs. RHE.

FIG. 31 shows In situ IRRAS of glycerol electrooxidation on Pd₃Cu. Conditions: 0.1 M KOH+1 M MeOH/EtOH (0.1 M EG/glycerol), V vs. RHE.

FIG. 32 shows FTIR linear voltammogram (-) and absorbance of CO₂ signal (--) on Pd₃Cu for 1 M ethanol. Conditions: 0.1 M KOH, 0 RPM, scan rate of 1 mV s⁻¹.

FIG. 33 shows FTIR linear voltammogram (-) and absorbance of CO₂ signal (--) on Pd₃Cu for 1 M methanol. Conditions: 0.1 M KOH, 0 RPM, scan rate of 1 mV s⁻¹.

FIG. 34 shows FTIR linear voltammogram (-) and absorbance of CO₂ signal (--) on Pd₃Cu for 0.1 M glycerol. Conditions: 0.1 M KOH, 0 RPM, scan rate of 1 mV s⁻¹.

FIG. 35 shows FTIR linear voltammogram (-) and absorbance of CO₂ signal (--) on Pd₃Cu for 1 M ethylene glycol. Conditions: 0.1 M KOH, 0 RPM, scan rate of 1 mV s⁻¹.

FIG. 36 shows DEMS results for the ethylene glycol oxidation at PdCu catalysts in 1 mM EG, 0.1 M KOH solution, MSCV at a scan rate of 10 mV s⁻¹, conditions values recorded after 20 min.

FIG. 37 shows DEMS results for the ethylene glycol oxidation at PdCu catalysts in 1 mM EG, 0.1 M KOH solution, CCE under potentiostatic conditions values recorded after 20 min.

FIG. 38 Chronoamperometry for Pd₃Cu at 0.7 V vs. RHE for 0.1M glycerol, 0.1 ethylene glycol, 1M ethanol and 1M methanol. Conditions: 1M KOH, RT, 0 RPM, N₂ purge.

FIG. 39 is XRD diffractograms for palladium-lead catalysts with variation of Pd:Pb ratio synthesized by SSM.

FIG. 40 is an SEM image of PdPb₃ prepared as described herein.

FIG. 41 is an SEM image of PdPb prepared as described herein.

FIG. 42 is an SEM image of PD₃Pb prepared as described herein.

FIG. 43 is a TEM image of PdPb₃ prepared as described herein.

FIG. 44 is a TEM image of PdPb prepared as described herein.

FIG. 45 is a TEM image of Pd₃Pb prepared as described herein.

FIG. 46 is a cyclic voltammogram of MeOH electrooxidation by different Pd—Pb catalysts: PdPb₃ (-), PdPb (- - -), Pd₃Pb (• • •) and Pd (- • -). Conditions: 1M KOH+1M MeOH/EtOH (0.1 M EG/glycerol), catalyst loading −200 μg cm⁻², 1600 RPM, 20 mV s⁻¹.

FIG. 47 is a cyclic voltammogram of EtOH electrooxidation by different Pd—Pb catalysts: PdPb₃ (-), PdPb (- - -), Pd₃Pb (• • •) and Pd (- • -). Conditions: 1M KOH+1M MeOH/EtOH (0.1 M EG/glycerol), catalyst loading −200 μg cm⁻², 1600 RPM, 20 mV s⁻¹.

FIG. 48 is a cyclic voltammogram of EG electrooxidation by different Pd—Pb catalysts: PdPb₃ (-), PdPb (- - -), Pd₃Pb (• • •) and Pd (- • -). Conditions: 1M KOH+1M MeOH/EtOH (0.1 M EG/glycerol), catalyst loading −200 μg cm⁻², 1600 RPM, 20 mV s⁻¹.

FIG. 49 is a cyclic voltammogram of glycerol electrooxidation by different Pd—Pb catalysts: PdPb₃ (-), PdPb (- - -), Pd₃Pb (• • •) and Pd (- • -). Conditions: 1M KOH+1M MeOH/EtOH (0.1 M EG/glycerol), catalyst loading −200 μg cm⁻², 1600 RPM, 20 mV s⁻¹.catalysts.

FIG. 50 shows FTIR imaging of the oxidation of 0.1M ethylene glycol on PdPb₃ prepared as described herein (V vs. Hg/HgO).

FIG. 51 shows FTIR imaging of the oxidation of 0.1M glycerol on PdPb₃ prepared as described herein (V vs. Hg/HgO).

FIG. 52 shows FTIR imaging of the oxidation 1M methanol on PdPb₃ prepared as described herein (V vs. Hg/HgO).

FIG. 53 shows FTIR imaging of the oxidation of 1M ethanol on PdPb₃ prepared as described herein (V vs. Hg/HgO).

FIG. 54 Solid lines show the FTIR linear voltammetry of fuel electrooxidation by PdPb₃ prepared by thermal reduction at a scan rate of 1 mV s⁻¹. Dashed lines show the appearance of the asymmetric stretch of CO₂ (˜2340 cm⁻¹) as a function of potential. Conditions: 1M KOH, room temperature, 0 RPM, Ar purge.

FIG. 55 Chronoamperometry for PdPb₃ prepared by thermal reduction at −0.2 V vs. Hg/HgO for 0.1M glycerol, 0.1 ethylene glycol, 1M ethanol and 1M methanol. Conditions: 1M KOH, room temperature, 0 RPM, N₂ purge.

### DETAILED DESCRIPTION

According to various embodiments the present disclosure provides novel materials that are capable of oxidation and conversion of water-soluble carbon-containing and non-carbon containing fuels and novel methods for making the same. According to various embodiments, such materials are suitable for use as catalysts in DLFFCs including in DLFFCs that utilize alcohols-based fuels (DAFCs), among other applications. According to various embodiments, these materials are molecular alloys of at least two metals which, when formed as an alloy, synergistically increase the oxidative and conversion properties of the alloy above the levels produced by either metal alone. According to still further embodiments, at least one of the metals is palladium.

For the purposes of the present disclosure, the terms “alloy,” “metal alloy,” and “alloy material” are used to describe materials in which a molecular alloy has been produced between at least two metals. A “molecular alloy” is produced when two metal salts reduce at the same time in close proximity to each other in order to produce a homogenous or true alloy. For simplicity, the terms “alloy,” “metal alloy,” and “alloy material” are also used herein to continue to refer to those materials wherein at least some of one of the metals in the alloy has been removed as a post-processing step after the alloy was formed using the methods described herein.

Palladium and palladium-based materials have wide applications in the field of fuel cells, particularly because these materials can be used in either the cathode or the anode in the membrane electrode assembly (MEA) in anion exchange fuel cells. The use of anion exchange fuel cells has the further advantage of reducing fuel cross-over.

As indicated above, according to various embodiments the present disclosure provides a method for producing novel palladium-alloy materials. The method utilizes a sacrificial template-based approach that enables the production of unsupported materials having a unique and predetermined morphology. According to various embodiments of the sacrificial support-based method, sacrificial support particles are mixed with metal precursors, either in solution, or using mechanosynthesis means as described below, in order to coat, deposit, impregnate, infuse, or similarly associate the metal precursors on or in the sacrificial support particles thereby producing or initiating the production of a support particle-metal precursory composite material. For the sake of simplicity, unless otherwise specified, the term “coat” is used herein as a catchall phrase to refer to any type of physical association, whether or not the “coating” is complete or partial and whether exclusively external or both internal and external. As an example, a sacrificial template solution may be produced, for example, by dispersing the support particles in any solvent which can dissolve or disperse the precursors and or support particles such as, for example, water. Once formed, the support particle-metal precursor composite material is then allowed to dry until a dry powder is formed. If desired, the dry powder may then be treated, for example by grinding with mortar and pestle, to produce a fine powder. The composite material is then reduced to form an alloy from the metal precursors. In some embodiments, the composite materials are thermally reduced, for example with hydrogen, and then passivated in a flow of technical grade of any inert gas with trace amounts of oxygen including, but not necessarily limited to nitrogen. Alternatively or additionally, the metal precursors could be reduced or co-reduced with chemical agents such as NaBH₄, N₂H₄, polyols, or the like. The sacrificial support is then removed, for example via chemical etching or other suitable means resulting in a porous unsupported metal alloy material. The porous unsupported metal alloy can then be rinsed, for example, with deionized water until it achieves a neutral reaction with water.

For the purposes of the present disclosure, the term “precursor” is used to refer to a compound which participates in a chemical reaction by contributing one or more atoms to a compound that is formed as the product of the chemical reaction or otherwise contributes to the formation of the product. For example, nitrates, chlorides, acetates, hydroxides etc.

For the purposes of the present disclosure, the term “sacrificial template” is intended to refer to a material that is included during the synthesis process in order to provide temporary structure but which is mostly or entirely removed during the synthesis process. As described in greater detail below, according to various embodiments, the sacrificial template takes the form of a sacrificial particles (also referred to herein as “sacrificial template particles”.)

Those of skill in the art will understand that the metals selected to form the alloy will be determined by the intended use of the final product material. Accordingly, if the material is to be used as a catalyst, suitable metals include, but are not limited to Pd, Cu, Bi, Pb, Co, Ni, Mn, Fe, Ag, Au, Pt, Rh, Ir, V, Cr with at least one of the metals in the alloy being palladium. It should also be understood that the metal precursors can be mixed together at various ratios to produce alloys having different chemical compositions. Specific examples and additional details related to this are described in the Examples section below.

It will be appreciated that the present disclosure often makes reference to “metal precursors.” It should be understood that such terminology is used to refer to a metal-containing compound wherein the metal is available for chemical synthesis. Examples of metal precursors include metal salts such as nitrates, chlorides, acetates, hydroxides etc. Accordingly, while the specific metal precursors used should be selected based on the intended final product, according to various embodiments, metal nitrates such as Pd(NO₃)₂, Cu(NO₃)₂, Bi(NO₃)₃, and Pb(NO₃)₂ are suitable metal precursors for the methods disclosed herein.

According to some embodiments, the metal precursors and sacrificial support particles may be mixed together under aqueous conditions using known solvents such as water, alcohols, or the like and using various known mechanical mixing or stifling means under suitable temperature, atmospheric, or other conditions as needed in order to enable or initiate alloying. Suitable mixing means include, for example, use of an ultrasound bath, which also enables dispersion of the sacrificial support particles.

According to other embodiments the metal precursors and sacrificial support particles may be mixed together using mechanosynthesis techniques such as ball-milling, which do not necessarily require solvents. Ball-milling has been described previously in referenced to metal-nitrogen-carbon catalyst material synthesis as a method for filling the pores of a carbon support with a pore-filler. However, in the methods described in the present disclosure, ball-milling is used to enable mechanosynthesis, alleviating the need for solvent-based preparation methods. In general, the presently described methods utilize the energy produced by ball-milling of the various precursor materials to drive a chemical reaction between the precursors. According to a more specific example, an alloyed material according to the present disclosure may be synthesized by ball milling the sacrificial support and metal precursors under sufficient conditions to initiate a reaction between the various precursors, thereby forming (or initiating formation of) the metal alloy.

For the purposes of the present disclosure, the term “ball mill” is used to refer to any type of grinder or mill that uses a grinding media such as silica abrasive or edged parts such as burrs to grind materials into fine powders and/or introduce to the system enough energy to start a solid state chemical reaction that leads to the formation of a catalyst. In general, for the purposes of the present disclosure, the ball mill used should be capable of producing enough energy to initiate the desired chemical reaction or achieve the desired level of mixing.

According to some embodiments, the entire process is performed dry, by which is meant, without the presence of any added solvents. According to one embodiment of a solvent-free process, all initial materials (i.e. the metal precursors and sacrificial support particles) are combined in a ball mill in powder form and the entire process is conducted without the addition of any liquids. For the purposes of the present disclosure, a powder is a dry, bulk solid composed of a large number of very fine particles that may flow freely when shaken or tilted. Because the method can be practiced without the presence of any solvents, the method enables the synthesis of materials formed from or including insoluble materials. Of course it will be appreciated that while the mechanosynthesis method does not require the addition of solvents, solvents may be used, if desired.

It should be appreciated that the presently disclosed methods enable the production of materials having highly controllable morphology. Specifically, by selecting the ratio of sacrificial support particles to metal precursor materials and the size, shape, and even porosity of the sacrificial template particles, it is possible to both control, select, and fine-tune the internal structure of the final product. In essence, the disclosed method enables the production of a material having as convoluted and tortuous an internal structure as desired. For example, a highly porous open-structure “sponge-like” material may be formed by using larger sacrificial template particles, while a highly convoluted, complex internal structure may be formed by using smaller, more complexly shaped, sacrificial particles, including for example, sacrificial particles of different shapes and/or sacrificial particles which are themselves porous. Moreover, the “density” of the catalyst can be selected by altering, for example, the ratio of sacrificial particles to metal precursor materials, the shape of the template particles (i.e. how easily they fit together), or other factors.

It will be appreciated that removal of the template particles will produce a material comprising a plurality of voids that exist where the template particles had originally resided in the silicon-metal alloy composite material. For the purposes of the present disclosure, the term “void” is used to refer to a space that is created by the removal of some or all of a material that had been in situ formed during reduction of the silicon and metal precursors.

Accordingly, it will be appreciated that the size and shape of the sacrificial support particles may be selected according to the desired shape(s) and size(s) of the voids within the final product. Specifically, it will be understood that by selecting the particular size and shape of the support particles, one can produce an alloy material having voids of a predictable size and shape. For example, if the template particles are spheres, the catalyst will contain a plurality of spherical voids having the same general size as the spherical particles. For instance, assuming there is no alteration in the size of the particle caused by the synthesis method, in an embodiment where particles having an average diameter of 20 nm is used, the spherical voids in the catalyst will typically have an average diameter of approximately 20 nm. (Those of skill in the art will understand that if the diameter of the particle is 20 nm, the internal diameter of the void in which the particle resided will likely be just slightly larger than 20 nm and thus the term “approximately” is used to account for this slight adjustment.)

Accordingly it will be understood that the sacrificial support particles may take the form of any two- or three- dimensional regular, irregular, or amorphous shape or shapes, including, but not limited to, spheres, cubes, cylinders, cones, etc. Furthermore, the particles may be monodisperse, or irregularly sized.

It will be further understood that because the alloy materials are formed using a sacrificial template technique, where the sacrificial material can be, for example, “melted” out of the templating materials using acid etching or other techniques, the resulting alloy materials can be designed to have a variety of variously shaped internal voids which result in an extremely high internal surface area that is easily accessible to gasses or liquids including, for example, gas or liquid fuels used in a fuel cell. Furthermore, because the size and shape of the voids is created by the size and shape of the sacrificial particles, alloy materials having irregular and non-uniform voids can easily be obtained, simply by using differently shaped sacrificial particles and/or by the non-uniform distribution of sacrificial materials within the metal precursor/sacrificial particle mixture. Furthermore, the sacrificial-template based methods of the present disclosure may produce materials having, for example, a bi-modal (or even multi-modal) pore distribution either due to the use of differently sized sacrificial particles or where a first smaller pore size is the result of removal of individual particles and thus determined by the size of the sacrificial particles themselves and a second, larger, pore size is the result of removal of agglomerated or aggregated particles. Accordingly, it will be understood that the method described herein inherently produces a catalyst having a unique morphology that would be difficult, if not impossible, to replicate using any other technique.

As stated above, according to various embodiments, sacrificial particles of any size or diameter may be used. In some preferred embodiments, sacrificial particles having a characteristic length/diameter/or other dimension of between 1 nm and 100 nm may be used, in more preferred embodiments, sacrificial particles having characteristic length/diameter/or other dimension of between 100 nm and 1000 nm may be used and in other preferred embodiments, sacrificial particles having characteristic length/diameter/or other dimension of between 1 mm and 10 mm may be used. It should also be understood that the term “sacrificial particle” is used herein as a term of convenience and that no specific shape or size range is inherently implied by the term “particle” in this context. Thus while the sacrificial particles may be within the nanometers sized range, the use of larger or smaller particles is also contemplated by the present disclosure.

According to some embodiments, the sacrificial particles may themselves be porous. Such pores may be regularly or irregularly sized and/or shaped. The use of porous sacrificial particles enables the metal precursors to intercalate the pores, producing even more complexity in the overall three-dimensional structure of the resulting catalyst.

It will be appreciated that the sacrificial template particles may be synthesized and mixed (or coated, or infused, etc.) in a single synthesis step or the metal precursors may be mixed with pre-synthesized (whether commercially purchased or previously synthesized) sacrificial particles.

Of course it will be appreciated that given the various conditions that the sacrificial template will be subjected to during the synthesis process, it is important to select a template material which is non-reactive under the specific synthesis conditions used and the removal of which will not damage the final material. Silica is a material which is known to easily withstand the conditions described herein while remaining inert to a variety of materials including catalytic materials and the metals described herein. Furthermore, silica can be removed using techniques that are harmless to a wide variety of metal alloys as well as to active sites in those metal alloys. Thus, silica is considered to be a suitable material from which the sacrificial template particles can be made. According to some specific embodiments, 20 nm diameter spheres formed from mesoporous silica can be used. In this case the templating involves intercalating the mesopores of the silica template particles and the resulting material typically contains pores in the 2-20 nm range. In one particular embodiment, the silica template is commercially available Cabosil EH-5 amorphous fumed silica (400 m²/g). Those of skill in the art will be familiar with a variety of silica particles that are commercially available, and such particles may be used. Alternatively, known methods of forming silica particles may be employed in order to obtain particles of the desired shape and/or size.

However, while many of the examples herein utilize silica for the templating materials, it will be appreciated that other suitable materials may be used including, but are not limited to, zeolites, aluminas, cooking salts, or any other material that can be used as a template and then removed without harming the desired final structure.

As stated above, after the metal precursors are mixed with the sacrificial support to produce an metal alloy-sacrificial support mixture, the mixture is allowed to dry until a dry powder is produced. The dry powder can then be ground to a desired particle size, as desired. The resulting powder is then reduced.

According to some embodiments, reduction occurs by heat treatment. According to some embodiments, heat treatment may preferably be between 80° C. and 800° C., or more preferably around 300° C., as our experimental data showed this temperature to produce catalysts having a high amount of catalytic activity for certain specific materials (see example section below).

After reduction, the sacrificial template particles are removed resulting in a self-supported porous, metal alloy. In some cases the catalyst consists only of materials derived from the metal precursors. Removal of the sacrificial template particles may be achieved using any suitable means. For example, the template particles may be removed via chemical etching. Examples of suitable etchants include NaOH, KOH, and HF. According to some embodiments, it may be preferable to use KOH, as it preserves all metal and metal oxide in the material and, use of KOH may, in fact, increase catalytic activity of the active centers. Alternatively, in some embodiments, HF may be preferred as it is very aggressive and can be used to remove some poisonous species from the surface of the material. Accordingly, those of skill in the art will be able to select the desired etchants based on the particular requirements of the supporting material being formed.

In some embodiments, it may be desirable to add a second heat treatment, in order to clean the surface of the alloy material. In this case, it may desirable for the different heat treatment steps to be conducted under different conditions, for example at different temperatures and/or for different durations of time. For example, the first heat treatment step may be performed at a higher temperature, such as 800° C. for 1 hour and the second heat treatment step may be performed at a temperature between 80 and 100° C. for a period of time between 10 minutes and 1 hour.

After the sacrificial support is removed, the alloy material may be further processed to prepare the material to be deposited, painted, layered, attached, inserted, or otherwise associated with another, for example supporting, material. For example, the metal alloy could be ground or ball-milled, if necessary, to obtain a powder having a desired particle size. Moreover, the metal alloy material could be mixed with a carbon black such as Vulcan XC-72 (Cabot, Corporation, Billerica, Mass.) and an ionomer such as Nafion (E.I. du Pont de Nemours and Company, Buffalo, N.Y.) to form an ink which can then be sprayed or otherwise deposited onto a surface. The metal alloy material, carbon black, and ionomer can be mixed together in any suitable or desired ratio.

Alternatively, if desired, some or all of one or more of the metals in the metal alloy could be removed, for example, via etching, to produce a material having a still further unique morphology at the mesoscale, to alter geometric nanoscale properties including at the atomic level, or to alter specific electronic properties such as electronic density. For simplicity, unless explicitly stated otherwise, the term “metal alloy” as used herein is intended to include the final product of the processes described herein even if one of the metals in the metal alloy has been removed as described in this paragraph.

As stated above, the alloy materials may be used as or as part of a catalyst for a fuel cell. As will be understood better after review of the Examples section below, palladium-based alloy catalysts wherein one of the metal precursors used in a precursor of palladium as described herein can be used to catalyze reactions in alkaline media utilizing both water-soluble carbon containing and non-carbon containing fuels including, but not limited to, methanol, formic acid, formate, ethanol, glycerol, isopropanol, and C1, C2, and C3 fuels in general. Furthermore, these materials can also be used to catalyze non-carbon containing fuels such as ammonia, borohydrate, hydrazine, ammonia borine, and ammonia hydrazine because the presence of the second metal in the alloy modulates palladium towards oxidation and/or conversion of a wide variety of fuels.

It should be appreciated that the unique morphologies, including the presence of the uniquely shaped voids, that can be produced by the presently described methods are believed to contribute to the ability of the herein described metal alloy to act as an effective and efficient fuel cell catalyst. Specifically, it is believed that the mass activity of the presently described material is increased due to the presence of pits or holes in the material that trap (or “nano-confine) molecules—effectively mimicking specific adsorption. Furthermore, our research indicates that the surface of the pits have electronic properties that increase adsorption.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. The methods and processes illustratively described herein suitably may be practiced in differing orders of steps, and that they are not necessarily restricted to the orders of steps indicated herein or in the claims. As used herein and in the appended claims, the singular forms “a,” “an,” and “the” include plural reference unless the context clearly dictates otherwise. Thus, for example, a reference to “a host cell” includes a plurality (for example, a culture or population) of such host cells, and so forth.

Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

All patents and publications referenced below and/or mentioned herein are indicative of the levels of skill of those skilled in the art to which the invention pertains, and each such referenced patent or publication is hereby incorporated by reference to the same extent as if it had been incorporated by reference in its entirety individually or set forth herein in its entirety. Applicants reserve the right to physically incorporate into this specification any and all materials and information from any such cited patents or publications.

### REFERENCES

Grden, M.; [symbol] ukaszewski, M.; Jerkiewicz, G.; Czerwinski, A. Electrochim. Acta 2008, 53, 7583-7598.
Simões, M.; Baranton, S.; Coutanceau, C. J. Phys. Chem. C 2009, 113, 13369-13376.
Wagner, C. D.; Riggs, W. M.; Davis, L. E.; Moulder, J. F.; Mouilenberg, G. E.; Eds.; in Handbook of Xray Photoelectron Spectroscopy, Perkin Elmer Corporation: Eden Prairie, Minn., 1978, p. 1.
Falase, A.; Main, M.; Garcia, K.; Serov, A.; Lau, C.; Atanassov, P. Electrochim. Acta 2012, 66, 295-301.
Wang, L.; Meng, H.; Shen, P. K.; Bianchini, C.; Vizza, F.; Wei, Z. Phys. Chem. Chem. Phys. 2011, 13, 2667-2673.
Pouchert, C. J. in The Aldrich Library of Infrared Spectra, 3rd ed. Aldrich Chemical Company, Inc.: Milwaukee, 1981, p. 1.
Simões, M.; Baranton, S.; Coutanceau, C. Appl. Catal. B: Env. 2010, 93, 354-362.
Léger, J.-M.; Rousseau, S.; Coutanceau, C.; Hahn, F.; Lamy C. Electrochim. Acta 2005, 50, 5118-5125.
Dubau, L.; Hahn, F.; Coutanceau, C.; Léger, J.-M.; Lamy, C. J. Electroanal. Chem. 2003, 554-555, 407-415.
Kunimatsu, K. J. Electroanal. Chem. 1982, 140, 205-210.
Beden, B.; Hahn, F.; Juanto, S.; Lamy, C.; Léger, J.-M. J. Electroanal. Chem. 1987, 225, 215-225.
Schmidt, T. J.; Behm, R. J.; Grgur, B. N.; Markovic, N. M.; Ross Jr., P. N. Langmuir 2000, 16, 8159-8166.
Podlovchenko, B. I.; Petrii, 0. A.; Frumkin, A. N.; Lal, H. J. Electronal. Chem. 1966, 11, 12-25.
Smirnova, N. W.; Petrii, 0. A.; Grzejdziak, A. J. Electroanal. Chem. 1988, 251, 73-87.
Adzic, R. R. Electrocatalysis on surfaces modified by foreign metal adatoms. In Advances in Electrochemistry and Electrochemical Engineering; Gerisher, H.; Tobias C. W.; Eds.; Wiley- Interscience: New York, Vol. 13, 1984, pp. 159-260.
Kwon, Y.; Birdja, Y.; Spanos, I.; Rodriguez, P.; Koper, M. T. M. ACS Catal. 2012, 2, 759-764.

### Example I

### PdₓBi Materials

### Preparation of PdₓBi Materials

Synthesis of self-supported PdₓBi catalysts: a series of catalysts with various Pd:Bi ratios was prepared by the sacrificial support method disclosed herein. A known amount of silica Cab-O-Sil® EH-5 (surface area ˜400 m⁻² g⁻¹) was dispersed in water with an ultrasonic probe. Then, the appropriate amounts of metal precursors Pd(NO₃)₂.xH2O (metal content=40 wt %) and Bi(NO₃)₃ (metal content=42.98 wt %) from Sigma-Aldrich were added to the silica suspension. Total loading of metals on silica was calculated to be 13 wt %. The silica/precursor mixture was allowed to dry overnight. The composite materials were reduced under hydrogen atmosphere (7% H₂) at 300° C. for 2 h. After reduction, silica template was removed by etching in 7 M KOH solution, and abundantly washed with water until neutral pH was achieved. The nominal Pd to Bi atomic ratios were selected as 6:1, 4:1 and 2:1. The catalysts were denominated as Pd, Pd₆Bi₁, Pd₄Bi₁ and Pd₂Bi₁.

Characterization Methodologies

Physicochemical characterization: the catalysts were comprehensively characterized by Scanning Electron Microscopy (Hitachi S-5200 Nano SEM with an accelerating voltage of 10 keV), Transmission Electron Microscopy (JEOL 2010 TEM instrument with an accelerating voltage of 200 keV), Energy Dispersion Spectroscopy (EDS), X-ray Photoelectron Spectroscopy (XPS Kratos Ultra DLD spectrometer) and nitrogen adsorption (N2-BET method using Micrometrics 2360 Gemini Analyzer). SEM and TEM provided information about morphology of samples and size of nanoparticles while EDS and XPS were used to determine the composition of the samples for comparison with the expected composition. XPS was also used to determine the oxidation states and the eventual interactions between different elements in the materials.

Electrochemical characterization: the inks for cyclic voltammetry (CV) experiments were prepared by dispersing 5 mg of catalyst powder with 925 μL of a water and isopropanol alcohol (4:1) mixture, 75 μL of Nafion™ (0.5 wt % from DuPont). Homogeneity of the inks was achieved by means of sonication using an ultrasound probe. Then, 10 μL of the mixture was applied onto a 0.2472 cm2 geometric surface area glassy carbon disk, leading to a catalyst loading of 0.2 mg cm⁻². The electrochemical analysis of the synthesized material was performed using the Pine Instrument Company electrochemical analysis system. The cyclic voltammetry experiments were performed using a disk electrode rotated at 1300 revolution per minute (rpm). The electrolyte was 1 M KOH saturated with N₂ at room temperature. A platinum wire and Hg/HgO electrode were used as counter and reference electrodes, respectively, although all potentials are quoted versus the reversible hydrogen electrode (RHE). Electro-catalytic measurements were realized in 1 M KOH+0.1 M fuel solution at a scan rate 0.02 V s⁻¹. The voltammograms were recorded in the range of potentials from 0.0V to 1.4V vs RHE. The catalysts were cycled through the potential range several times until stable voltammograms were recorded. To assess the stability of materials, chronoamperometry were performed in presence of 0.1 M glycerol for 5000 seconds at a potential of 0.7 V vs RHE for the most active catalyst Pd₄Bi₁.

In situ FTIR spectroscopy (IRRAS—Nicolet 6700 FT-IR spectrometer with MCT detector) was used to gain insight into the mechanism of the alcohols electro oxidation on the self-supported Pd₄Bi₁ catalyst in alkaline media. The experimental method is described for example in Serov, A.; Robson, M. H.; Smolnik, M.; Atanassov, P. Electrochim. Acta 2013, 109, 433-439.

Analysis of PdₓBi Materials

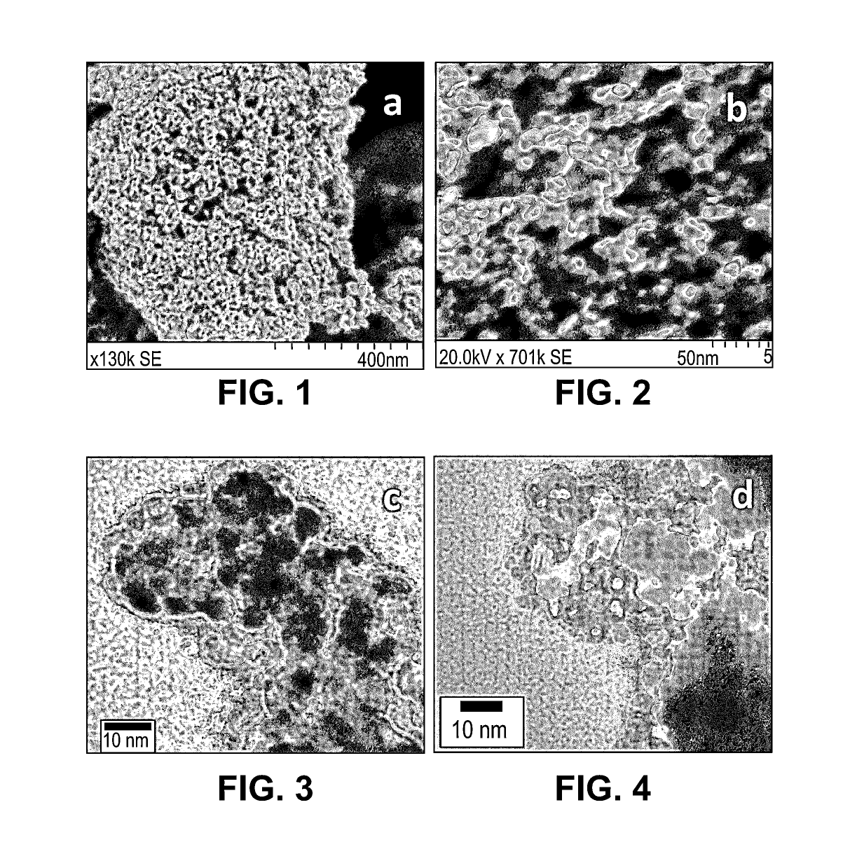

The sacrificial support method leads to self-supported bimetallic PdₓBi materials with a sponge-like structure as shown in SEM image of FIG. 1. At higher SEM magnification FIG. 2 shows clearly that unsupported Pd₄Bi₁ material displays nano-structured morphology. It was expected that the presence of beads of metals delimiting pores would increase the active surface area and further increase the catalyst utilization. This was confirmed as all catalysts presented a well-developed 3D structure and very high surface areas as determined by the N₂-BET results of between 75 and 100 m² g⁻¹, despite the use of moderately high temperatures during synthesis. The TEM images in FIGS. 3 and 4 also clearly show that the metal beads are composed of agglomerated nanoparticles with a size of ca. 5 nm. In summary, the self-supported PdₓBi materials prepared as described herein present as beads of agglomerated nanoparticles with a diameter of ca. 5 nm delimiting pores with sizes from 30 to 100 nm.

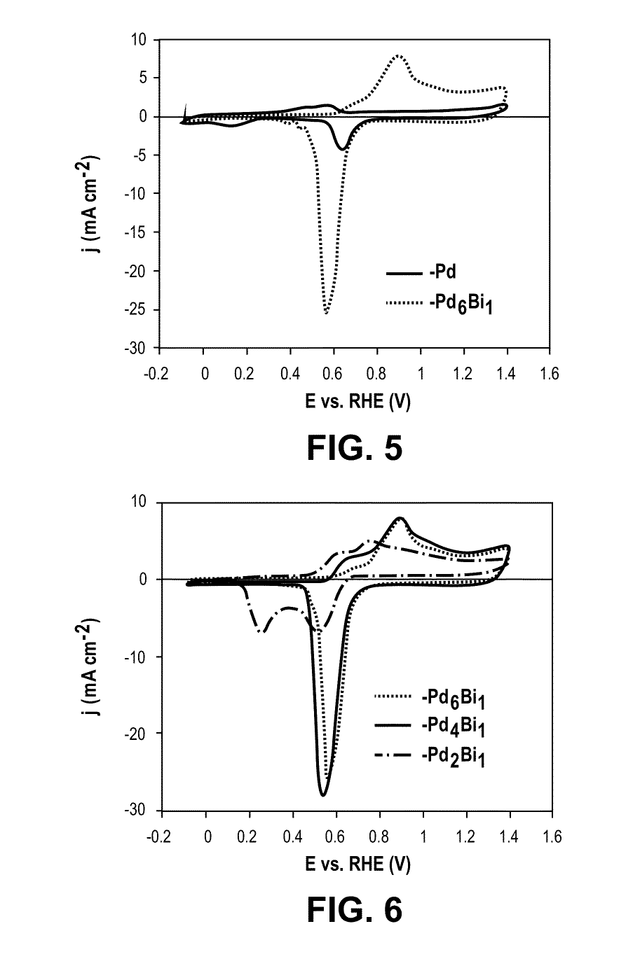

Cyclic voltammograms in supporting electrolyte are presented in FIGS. 5 and 6. For the pure Pd material, a typical voltammogram of polycrystalline palladium is obtained, with the adsorption/absorption region of hydrogen at low potentials (between 0.3 V and −0.1 V) in the negative going scan, the hydrogen desorption peak in the positive going scan between −0.1 and 0.7 V, followed by the Pd surface oxide region from 0.7 V to 1.4 V and in the reverse scan the reduction peak of Pd oxide species at ca. 0.6V, according to the following equation:

Pd+2OH⁻=PdO+H₂O+2e⁻

Under the present experimental conditions, the electrochemical surface area (ECSA) of the pure self-supported Pd catalyst can be calculated using the method described by Grdén et al., and was estimated ca. 20 m² g_{Pd}⁻¹. This value is four to five times lower than that determined by BET, indicating the presence of microporosity non accessible to hydrated species. But the ESCA is of same order than that obtained by Simões et al. with carbon supported Pd nanoparticles of 4.0 nm mean diameter, which is remarkable considering that the metal is not dispersed on a high specific surface area substrate such as carbon Vulcan XC72.

The presence of bismuth clearly affects the shape of the voltammograms by limiting the hydrogen adsorption/absorption processes on palladium at low potentials, as previously observed, (See e.g., Simões, M.; Baranton, S.; Coutanceau, C. Electrochim. Acta 2010, 56, 580-591) and changing the oxidation processes at high potentials. The hydrogen adsorption/absorption processes have almost completely disappeared for the self-supported Pd₆Bi₁ and Pd₄Bi₁ catalysts, indicating a high coverage of the palladium surface by bismuth atoms and strong interactions between bismuth and palladium atoms. A positive current peak related to a surface oxidation process appears with a maximum intensity located close to 0.9-0.95V.

According to the potential pH diagram of bismuth in aqueous medium (Van Muyder, J.; Pourbaix M. in Atlas d'équilibres électrochimiques à 25° C., Gauthier-Villars & Cie: Paris, 1963, pp. 533-539), the Bi₂O₃ bismuth oxide phase exists as its hydrated form Bi(OH)₃, which is insoluble in alkaline solutions, and this latter hydrated specie can be formed as soon as 0.48 V according to the following reaction:

Bi+6 OH⁻=2 Bi(OH)₃+6 e⁻

In the negative going potential scan, a sharp single reduction current peak is observable between 0.55 V and 0.6 V for the Pd₆Bi₁ and Pd₄Bi₁ catalysts with a higher intensity than for the pure Pd material. This reduction peak is attributed to the reduction of the surface oxides, including bismuth oxides formed during the positive going potential scan. (Casella, I. G.; Contursi, M. Electrochim. Acta 2006, 52, 649-657.) This suggests that bismuth redox process in Pd₆Bi₁ and Pd₄Bi₁ catalysts is related to the palladium redox process and this is evidence that electronic interaction between both metals occurs. This strong interaction avoids the possibility to determine the ECSA of the Bi containing catalyst, conversely to pure Pd material, but it can reasonably be stated that it is lower than that of the pure Pd catalyst. For higher bismuth content, several oxidation/reduction peaks appeared which are due to several redox reactions of bismuth species. The reduction of oxidized Bi surface species strongly interacting with palladium occurs at higher potentials than that of oxidized Bi surface species weakly or not interacting with palladium. (Demarconnay, L.; Brimaud, S.; Coutanceau, C.; Léger, J.-M. J. Electroanal. Chem. 2007, 601, 169-180.)

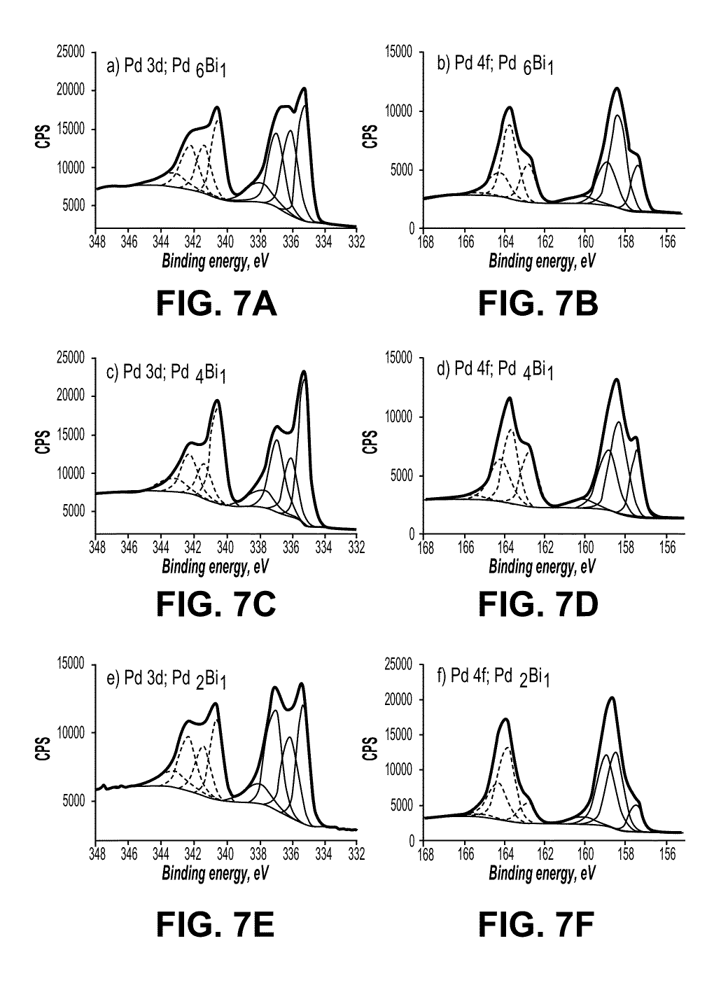

The XPS core level spectra of Pd 3d and bi 4f are presented in FIGS. 7A-7F for the three different PdₓBi materials. Different shapes of XPS spectra are obtained depending on the composition of catalyst. In PdₓBi materials, the 3d 5/2 core level spectra of palladium were better fitted with four symmetrical peaks at ca. 335, 336, 337 and 338 eV, assigned to Pd, Pd(OH)ₓ, PdO and PdO₂ species, respectively, as well as the 4f 7/2 core level spectra of bismuth fitted with four peaks at ca. 157, 158, 159 and 160 eV, which were attributed to Bi, Bi(OH)₃, BiOOH and Bi₂O₃ species, respectively. The spectrum analysis is based on data obtained from the “Handbook of X-ray Photoelectron Spectroscopy” and from previous studies by Casella and Contursi on bismuth atoms interacting with Pd surface, and also on the reasonable assumption that higher oxidation states of species lead to XPS peaks located at higher binding energies. Table 1 summarizes the main results of XPS analysis, as well as those from EDS characterization. The EDS data indicate a Pd enrichment of catalysts, whereas XPS indicated a Bi enrichment of the surface of the catalysts, but results are relatively close to the nominal atomic ratios.

TABLE 1

| | | | |
|---|---|---|---|
| Nominal at % | 86/14 (6:1) | 80/20 (4:1) | 66/33 (2:1) |
| EDS at % | 87/13 | 84/16 | 71.5/28.5 |
| XPS at % | 75/25 | 73.5/26.5 | 61/39 |

| | | | | | |
|---|---|---|---|---|---|
| BE[a] | | BE[a] | | BE[a] | |
| (eV) | at % | (eV) | at % | (eV) | at % |

XPS Pd species at %

| | | | | | | |
|---|---|---|---|---|---|---|
| Pd0 Pd(OH)x | 335.2 | 30.7 | 335.2 | 35 | 335.3 | 25 |
| PdO | 336.0 | 25.4 | 335.9 | 24 | 336 | 23.5 |
| PdO2 | 336.9 | 26.9 | 336.9 | 29.5 | 337.1 | 36.5 |
| | 337.8 | 17 | 338.1 | 11.5 | 338 | 15 |

XPS Bi species at %

| | | | | | | |
|---|---|---|---|---|---|---|
| Bi0 | 157.4 | 18.6 | 157.4 | 23 | 157.4 | 10 |
| Bi(OH)3 | 158.4 | 43.9 | 158.3 | 40 | 158.5 | 53.5 |
| BiOOH | 158.8 | 23.3 | 158.8 | 24.5 | 159 | 26 |
| Bi2O3 | 159.8 | 14.2 | 160 | 12.5 | 159.8 | 10.5 |

[a]Binding energy

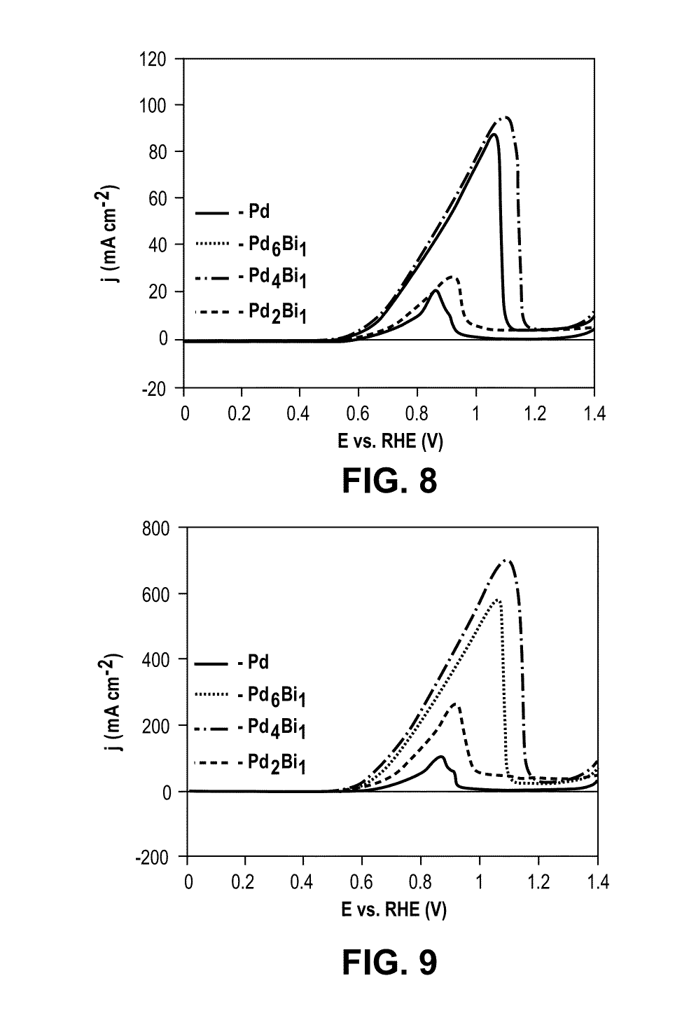

The electro-activity of the PdₓBi catalysts towards glycerol oxidation in alkaline medium was examined by voltammetry cyclic and compared with that of a pure Pd material. At a scan rate of 20 mV s⁻¹ (FIGS. 8, 9), an oxidation peak appears in the positive scan direction, starting from ca. 0.6 V for pure Pd material and Bi-rich one (Pd₂Bi₁) and from ca. 0.5 V for Pd₆Bi₁ and Pd₄Bi₁ materials. The promotion effect of bismuth for glycerol oxidation is evidenced by the shift of the onset oxidation potential by ca. 100 mV towards lower potentials and by the increase of the oxidation current densities from 0.5 to 1.2 V vs RHE. This clearly demonstrates an increased the reaction rate of glycerol oxidation in the presence of bismuth. Under these quasi stationary experimental conditions, the following order in activity was found: Pd₄Bi₁>Pd₆Bi₁>Pd₂Bi₁>Pd.

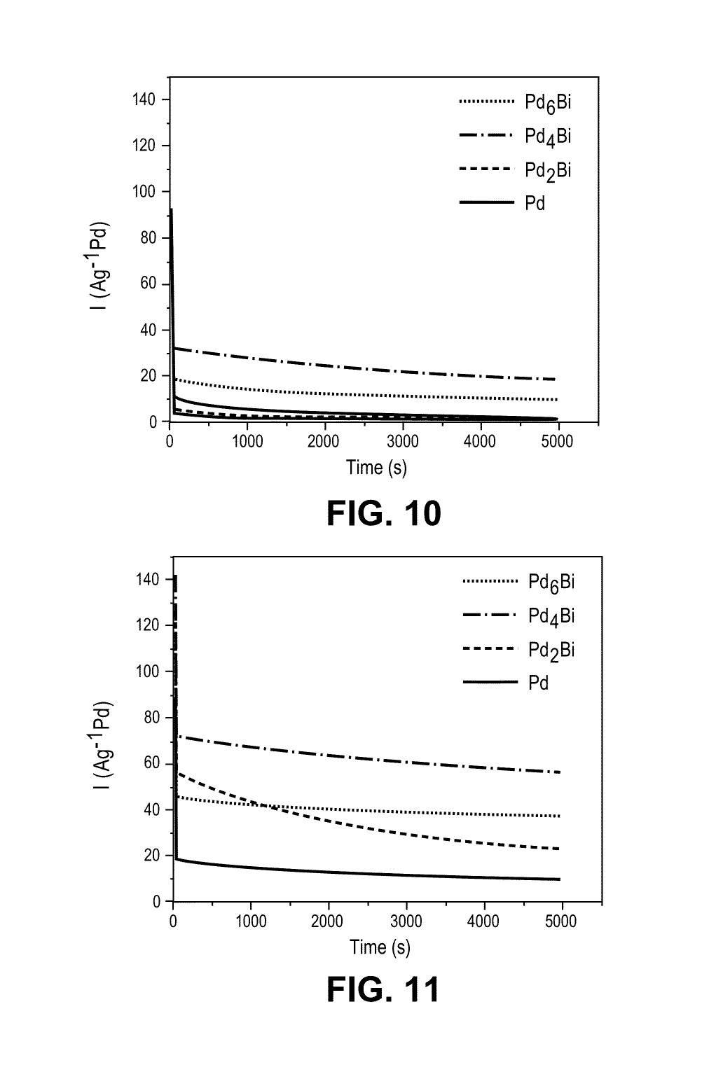

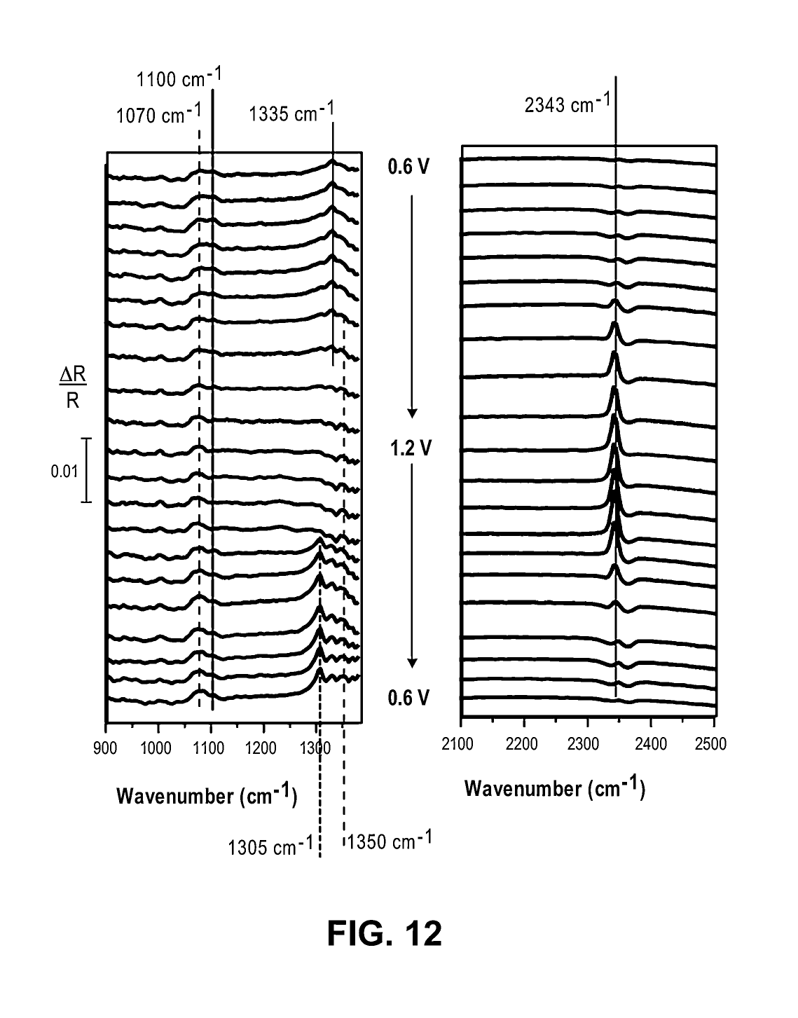

Chronoamperometry curves were recorded for 5000 seconds at 0.6 V and 0.7 V in presence of 0.1 M glycerol on different PdₓBi catalysts (FIGS. 10 and 11, respectively) and compared with those recorded on the pure Pd catalyst. At 0.6 V vs. RHE, the current recorded on both Pd and Pd₂Bi₁ catalysts drops rapidly towards a value close to zero, whereas on the Pd₆Bi₁ and Pd₄Bi₁ catalyst the current first decreases and stabilizes at ca. 10 A g_{Pd}⁻¹ and ca. 20 A g_{Pd}⁻¹, respectively, the Pd₄Bi₁ material being the most active one. At 0.7 V vs. RHE, the Pd₄Bi₁ material still remains the most active catalyst. After the initial current density of several hundreds of A g_{Pd}⁻¹, a dramatic drop of current to ca. 70 A g_{Pd}⁻¹ occurs in a few seconds for, likely related to capacitive current decay. Then a slow decrease and stabilization of the activity at ca. 60 A g_{Pd}⁻¹ occur, which is convenient with cyclic voltammetry (FIGS. 5 and 6). This behavior can be attributed to the formation of adsorbed species from glycerol at the surface of the catalyst leading to decreased active surface area and decreased glycerol oxidation activity until an equilibrium between adsorption of species from glycerol and desorption of reaction products is reached. These results not only highlight the higher activity of Bi containing catalysts, but also the better stability of the Pd₄Bi₁ material.

The in-situ infrared spectra recorded on Pd₄Bi₁ catalyst for glycerol oxidation in alkaline medium are presented in FIG. 6. The part of the spectra in the range from 1400 cm⁻¹ to 2000 cm⁻¹ was removed because the presence of water leads to IR absorption bands in this wavenumber region which superimpose with absorption bands of other species (such as carbonyl)^{37,38} and make interpretation impossible. In the IR fingerprint region, from 1000 cm⁻¹ to 1400 cm⁻¹, several absorption bands can be observed. In previous works,^{7,24} the assignation of the infrared absorption bands was confirmed by HPLC analysis of the reaction products after chronoamperometry experiments carried out at potentials where IR absorbed bands appeared. (See, Simões, M.; Baranton, S.; Coutanceau, C. ChemSusChem 2012, 5, 2106-2124 and Simões, M.; Baranton, S.; Coutanceau, C. Appl. Catal. B: Env. 2011, 110, 40-49.) The first one at ca. 1070 cm⁻¹ corresponds to CO stretching of aldehyde and is observable over the whole potential range in the positive as well as in the negative scan directions. In the positive scan direction, the absorption band at 1070 cm⁻¹ is accompanied from 0.6 V to ca. 0.9 V by two bands located at ca. 1100 cm⁻¹ and at ca. 1335 cm⁻¹, related to CO stretching of alcohol groups and to dihydroxyacetone (DHA), respectively. For potentials between 0.9 and 1.2 V, in both positive and negative scan directions, a well define absorption peak at ca. 1350 cm⁻¹, which only appeared as a shoulder for lower potentials in the positive scan direction, assigned to the formation of hydroxypyruvate, arises simultaneously with an absorption peak at ca. 2341 cm⁻¹ typical of interfacial CO₂ production. At last, over the 0.9 V to 0.6 V range in the negative scan direction, the peak of DHA at ca. 1335 cm⁻¹ becomes smaller than in the positive scan direction, whereas a new absorption at ca. 1305 cm⁻¹ corresponding to carboxylate groups accompanies the one of hydroxypyruvate. Astonishingly, no absorption band located between ca. 1800 cm⁻¹ and ca. 2100 cm⁻¹, which would have corresponded to bridge bonded or linear bonded CO on the noble metal surface, has been observed over the whole studied potential range.

The beneficial effect of modifying palladium nanostructure by bismuth for the oxidation of alcohol and particularly glycerol, was already pointed out. But, here it is shown that in the case of self-supported PdₓBi materials an optimal bismuth/palladium atomic ratio of 1 to 4 leads to enhanced activity. Simões et al. observed that in the case of carbon supported PdₓBi₁₋ₓ, the increase of the bismuth content in the catalyst formulation towards values higher than 10 at % did not change the activity of the catalyst for glycerol electro-oxidation. On the basis of TEM, EDX, XRD and electrochemical measurements, it was proposed that bismuth deposited on the carbon support formed clusters inactive for the glycerol oxidation reaction. The electrochemical characterization of PdₓBi materials in supporting electrolyte (FIGS. 3-5) indicated that the intensity and related charge in the reduction peak at ca. 0.55 V becomes lower as the bismuth content in the material increases; the Pd and strongly interacting Pd/Bi surfaces, responsible of this reduction peak, are then smaller at high bismuth content, whereas the surface of bismuth weakly or not interacting with Pd is higher as evidenced by the reduction peak at ca. 0.2 V vs. RHE. This observation can be confronted with the EDS and XPS data in Table 1 showing an enrichment of the material surface by bismuth as the Bi/Pd atomic ratio is increased. As the bismuth content is increased in the catalyst, islands or cluster of bismuth forms at the palladium surface, decreasing the Pd surface available for glycerol adsorption and the interface between Pd surface and Bi surface structures, where strong interaction between both metals occurs. The order in the catalytic activity (Pd₄Bi₁>Pd₆Bi₁>Pd₂Bi₁>Pd) is then due to the surface concentration of Bi. It has been proposed that the activity depended on the balance between i) an inhibiting effect due to blocking of active sites and a catalytic effect due to enhanced adsorption of OH_{ads} on sites adjacent to Bi, ii) the amount and composition of strongly chemisorbed species and the course of electro-oxidation mechanism, and (iii) the change in adsorbed species implied by the Pd surface atoms dilution by Bi surface atoms and strength of adsorption. Note that all these reasons also stand for explaining the higher stability of the self-supported Pd₄Bi₁ materials towards glycerol oxidation showed in FIG. 5.

Beyond the activity, it is also known that the modification of platinum group metals surface by foreign atoms influences the selectivity of the alcohol oxidation reaction. From studies on the electro-oxidation of alcohol containing more than one carbon atom on platinum modified by adatoms, Petrii and co-workers concluded that the presence of adatoms led to significant effects on the amount and course of electro-oxidation of strongly bonded species and that it was also possible that they affect the composition of chemisorbed species (and therefore the selectivity of the catalyst). And very interesting and unique is the behavior of the most active catalyst, i. e. the self-supported Pd₄Bi₁ material, in terms of selectivity. The first important observation is its high selectivity at low overpotentials (from 0.6 V vs RHE to ca. 0.8 V vs. RHE) towards low oxidized compounds, i. e. glyceraldehyde (GAl) and dihydroxyaceone (DHA), as evidenced by the absorption band at 1070 cm⁻¹ and 1335 cm⁻¹, respectively, appearing in this potential range. This indicates that the increase of activity induced by bismuth does not imply the so-called bifunctional mechanism where it is proposed that surface species from alcohol adsorption are oxidatively removed thanks to the presence of surface OH species from water adsorption following a Langmuir-Hinshelwood mechanism. Indeed, the formation of aldehyde and ketone groups from alcohols does not need the addition of extra oxygen atoms, so that the enhancement of activation is due to the increased turn over frequency of reactant on the catalytic surface, possibly induced by a different adsorption mode of glycerol because Pd adsorption site dilution by bismuth atoms. Adzic also proposed that Bi adatoms prevents the adsorption and the formation of the strongly bound intermediates which occupied multiple surface sites. In acidic media, Koper et al. observed that the presence of bismuth salt in the electrolyte lowered the onset potential of oxidation on a Pt/C electrode and enhanced the turnover frequency by forming a bismuth-related active site on the surface poised for secondary alcohol oxidation.

As soon as the electrode potential is increased, the formation of hydroxypyruvate (HyP) occurs as evidenced by the shoulder appearing at 1350 cm⁻¹ from ca. 0.8 V vs. RHE. In this case, the formation of the carboxylate function implies the addition of extra oxygen atoms and therefore the bifunctional mechanism. It is worth to note that in previous works on classical carbon supported Pd and PdBi based nanocatalysts, (See Simões, M.; Baranton, S.; Coutanceau, C. ChemSusChem 2012, 5, 2106-2124 and Simões, M.; Baranton, S.; Coutanceau, C. Appl. Catal. B: Env. 2011, 110, 40-49) the formation of GAl and DHA was observed by in situ FTIR measurement and HPLC analyses, whereas the formation of HyP was not detected on such catalysts, conversely to what is observed here. Such a compound was only detected with a pure Au/C nanocatalyst. (Simões, M.; Baranton, S.; Coutanceau, C. Appl. Catal. B: Env. 2010, 93, 354-362.)

It was proposed that an equilibrium between both DHA and GAl isomers existed and then, if at such high potentials the oxidation reaction kinetics of a primary alcohol group towards carboxylate group becomes much more higher than the isomerization reaction kinetics of DHA into GAl, HyP can be formed in such amount sufficient for its detection. The discrepancies between results obtained with carbon supported catalysts and self-supported materials come from the particular morphology and structure of the self-supported Pd₄Bi₁ which are responsible of this unique behavior: the pores of size in the range from ca. 30 nm to 100 nm work as confined nanoreactors leading to such selectivity.

For higher potentials, the production of CO₂ evidenced by the sharp absorption band at ca. 2343 cm⁻¹, starts just after the detection of hydroxypyruvate whereas the absorption band assigned to DHA tends to disappear. Here, the breaking of the C—C bond has obviously occurred, and it is likely that in addition to CO₂, other C₁ and C₂ species are also formed, which are not detected. Indeed, the absorption peak at ca. 1240 cm⁻¹ assigned to glycolate and at 1330 cm⁻¹ assigned to oxalate are not present in FIG. 6a. The absorption band a ca. 1400 cm⁻¹ assigned to carbonate and at ca. 1577 cm⁻¹ assigned to glycolate cannot be observed with the IRRAS method, because of the presence of the interfacial water absorption band which avoid the accurate determination of the other absorption bands. Again, from previous work on carbon supported nano-structured PdₓBi_{y}/C catalyst, no production of CO₂ was observed and it was proposed that the dilution of Pd atoms by Bi atoms led to change the adsorption of glycerol, avoiding the breaking of the C—C bond. Here, the confined nanoreactor as proposed before can again be invoked to explain this ability to break the C—C bond at high potential with HyP as a reaction intermediate. The low diffusion of products from the pores of the catalysts towards the bulk electrolyte leads to increase their residence time in the catalytic layer, so that over-oxidation of hydroxypyruvate towards CO₂ can occur. This may explain the absence of CO absorption bands although CO₂ is formed, by considering that this step related to the presence of hydroxypyruvate does not involve the formation of strongly adsorbed CO, making its further oxidation to CO₂ easier, as it was proposed elsewhere in the case of ethanol electro-oxidation involving acetaldehyde intermediate at PtSn catalyst. (See Léger, J.-M.; Rousseau, S.; Coutanceau, C.; Hahn, F.; Lamy C. Electrochim. Acta 2005, 50, 5118-5125 and Coutanceau, C.; Brimaud, S.; Dubau, L.; Lamy, C.; Léger, J.-M.; Rousseau, S.; Vigier, F. Electrochim. Acta. 2008, 53, 6865-6880.)

Considering the use of this catalyst as anode material in an alkaline electrolysis cell, low glycerol conversion and hydrogen production rate would occur at low overvoltage, but with production of high value added ketone/aldehyde products of great interest for pharmaceutical, polymer, food, etc., industries, whereas high glycerol conversion into CO₂ and hydrogen production rate would occur at higher overvoltages, according to the following equations:

at low electrolysis cell voltages (low anode overpotentials):

CH₂OH—CHOH—CH₂OH→CH₂OH—CO—CH₂OH+H₂

and,

CH₂OH—CHOH—CH₂OH—CH₂OH—CHOH—CHO+H₂

at high electrolysis cell voltages (high anode overpotentials)

CH₂OH—CHOH—CH₂OH+H₂O—CH₂OH—CO—COOH+3 H₂

and,

CH₂OH—CHOH—CH₂OH+3 H₂O→3CO2+7H₂

If we consider that the oxidation of glycerol into CO₂ could also leads to the formation of other C1 and C2 species (although not detected), the number of hydrogen molecules produced by oxidized glycerol molecules should range between 3 and 7. Moreover, in all cases, the energy of hydrogen production would be at least twice to three times lower than in the case of water electrolysis, as it only depends on the electrode potential. (See Lamy, C.; Jaubert, T.; Baranton, S.; Coutanceau, C. J. Power Sources, 2014, 245, 927-936.) For water electrolysis, the onset potential for the anodic oxygen evolution reaction is higher than 1.23 V vs. RHE (the standard water oxidation potential), whereas that for the glycerol oxidation at a Pd4Bi1 catalyst is ca. 0.5 V vs. RHE.

At last, it is worth noting a new absorption peak assigned to carboxylate group a ca. 1305 cm⁻¹ which appears below 0.95 V in the negative potential scan direction. In this scan direction, the catalyst surface is first covered by oxide species at high potentials which can transform into hydroxide surface species as the electrode potential is lowered. These species are able to provide the extra atoms of oxygen needed for the oxidation of glycerol or adsorbed species from glycerol into carboxylate species, according to the bifunctional mechanism. In contrary, in the positive scan direction, palladium surface is most likely under reduced form at low electrode potentials and surface hydroxide species can only be formed for potentials higher than 0.7-0.8 V vs. RHE, explaining the formation of aldehyde/ketone species at low potentials and hydroxypyruvate at higher potentials.

### Example II

### PdCu Materials

### Preparation of PdCu Materials

First, silica (Cab-O—Si™ EH-5, surface area: ˜400 m² g⁻¹) was dispersed in water using high energy ultrasound probe. Calculated amounts of Pd(NO₃)₂*xH₂O and Cu(NO₃)₂*xH₂O (Sigma-Aldrich) were then added to the silica solution. The total loading of metals on silica was calculated to be 25 wt %. The suspension of silica and metal precursors was allowed to dry on ultrasound bath overnight. The obtained dry powder was ground with mortar and pestle to fine powder. Thermal reduction was performed in 7% H₂ atmosphere (100 cm³ min⁻¹ flow rate) at T=300° C. After reduction, the catalysts were passivated in a flow of technical grade nitrogen (−0.1% 02). The silica support was etched by means of 8 M KOH overnight and the resulting unsupported Pd—Cu catalysts were washed with DI water until neutral reaction of water. The Pd to Cu ratio (atomic) was selected as 3:1, 1:1 and 1:3, and catalysts were denoted as Pd₃Cu, PdCu and PdCu₃, respectively. In order to compare the catalytic activity of Pd—Cu catalysts with Pd, unsupported palladium material was also synthesized by the method described above.

Characterization

The morphology, purity, and composition of the synthesized catalysts were determined using Scanning Electron Microscopy (SEM), Transmission Electron Microscopy (TEM), and X-Ray Energy Dispersive Spectroscopy (X-EDS). SEM and TEM provided information on the morphology of the bulk and individual particles of the catalysts while X-EDS was used to estimate the composition of the samples and compare to the expected composition.

Powdered samples were analyzed by X-ray diffraction (XRD) using a Scintag Pad V diffractometer (Bragg-Brentano geometry) with DataScan 4 software (from MDI, Inc.) for system automation and data collection. Cu K_{α} radiation (40 kV, 35 mA) was used with a Bicron Scintillation detector (with a pyrolitic graphite curved crystal monochromator). Surface areas were measured by the N₂-Brunauer-Emmett-Teller (BET) method using a Micromeritics 2360 Gemini Analyzer. Scanning Electron Microscopy (SEM) was performed using a Hitachi S-5200 Nano SEM with an accelerating voltage of 15 keV. Transmission electron microscopy (TEM) was performed using a JEOL 2010 instrument with an accelerating voltage of 200 keV.

In Situ Infrared Reflection Adsorption Spectroscopy (IRRAS) experiments were performed at room temperature with a Nicolet 6700 FT-IR spectrometer equipped with a Mercury Cadmium Telluride (MCT) detector cooled with liquid nitrogen. The experimental corresponding setup is described in D. A. Konopka, M. Li, K. Artyushkova, N. Marinkovic, K. Sasaki, R. Adzic, T. L. Ward, P. Atanassov, J. Phys. Chem. C, 115 (2011)3043-3056. For each spectrum, 128 interferograms acquired at a resolution of 8 cm⁻¹ with unpolarized light were co-added. Absorbance units of the spectra are defined as A=−log(R/R₀), where R and R₀ represent reflected IR intensities corresponding to the sample and reference single beam spectrum, respectively. Thus, a positive peak in the resulting spectrum indicates a production of species, while a negative peak indicates consumption or decrease in concentration of a species compared to the reference spectrum. The reference spectrum was collected at E=−1.10 V (vs. sat. Ag/AgCl). Reported potentials have been corrected to RHE. A thin layer of ink was pipetted onto a polished glassy carbon electrode with a diameter of 5 mm and used as the working electrode. A ZnSe hemisphere was used as the IR window, and the working electrode was pressed against the window, creating a thin solution layer with a thickness of a few micrometers. The incident angle of the IR radiation passing through the ZnSe window was 36°. Argon was used to purge the electrolyte while dry air was used to purge the spectrometer and chamber, reducing the spectral interference from ambient CO₂ and water vapor.

The electrochemical analysis of the synthesized material was performed using the Pine Instrument Company electrochemical analysis system. The rotational speed is reported at 1600 revolution per minute (RPM), with a scan rate of 20 mV sec⁻¹. The electrolyte was 1 M KOH saturated in N2 at room temperature. A platinum wire counter-electrode and a Hg/HgO reference electrode were used.

The working electrodes were prepared by mixing 5 mg of the Pd— Cu electrocatalyst with 925 μL of a water and isopropyl alcohol (4:1) mixture, and 75 μL of Nafion® (0.5% wt., DuPont). The mixture was sonicated before 10 μL was applied onto a glassy carbon disk with a sectional area of 0.247 cm². The loading of catalyst on the electrode was in all cases 0.2 mgₘₑₜₐₗ cm⁻².

Results and Discussion

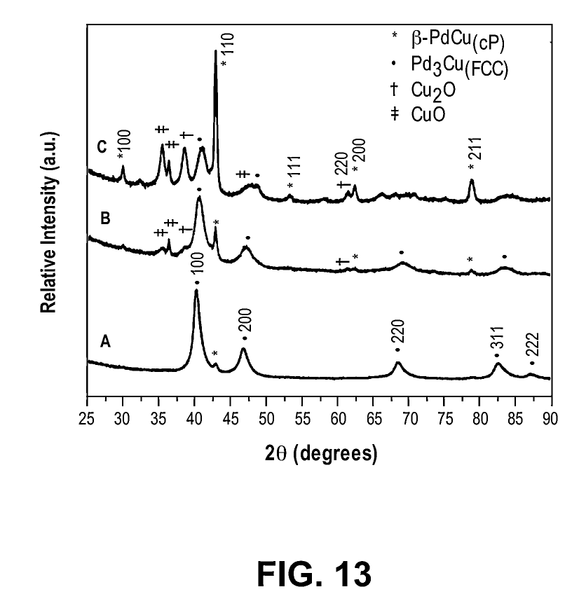

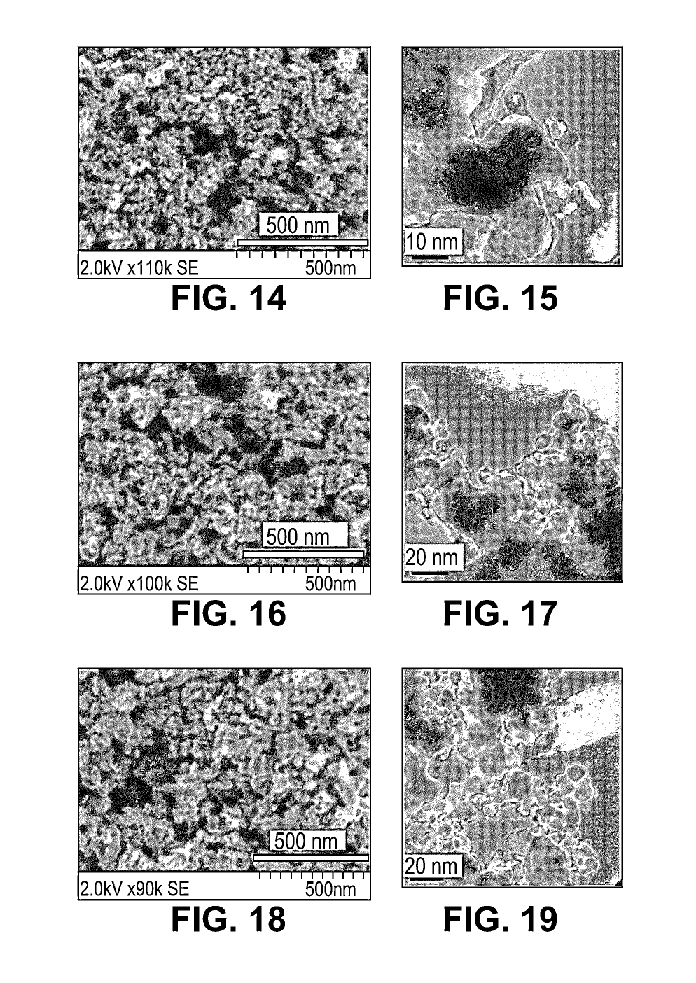

Analyzing the XRD data for PdCu₃, PdCu, and Pd₃Cu catalysts revealed that the samples have two palladium-copper phases: an FCC solid solution and the primitive cubic phase β-PdCu. Addition phases, Cu₂O and CuO, were present in samples with greater amounts of Cu (PdCu₃ and PdCu). The total mass fraction of Cu oxides was calculated by XRD pattern refinement to be 30 wt % and 57 wt % respectively. For the PdCu₃ catalyst (FIG. 13 top line) equal amounts of the FCC and primitive cubic phase were found, each with a mass fraction of 21 wt %. However, increasing amounts of Pd resulted in an increasing amount of the FCC solid solution; compositions being 61 wt % and 97 wt % for PdCu and Pd₃Cu catalysts respectively. Additionally, the lattice parameter of the FCC solid solution phase was found to increase by ˜1.0% between catalysts with each increase in Pd content (3.7973 Å, 3.8363 Å, and 3.8782 Å respectively). This result is consistent with the solid solution phase becoming more Pd rich. Crystallite domain size for the Pd—Cu phases was also calculated using Sherrer analysis. For the FCC phase, the average domain size for PdCu₃, PdCu, and Pd₃Cu catalysts were 7 nm, 6 nm, and 10 nm respectively. For the primitive cubic phase the average domain sizes were similar, being 21 nm, 20 nm, and 18 nm respectively. Morphological information for the Pd—Cu system was obtained by SEM imaging. It can be seen in FIGS. 14-19 that all materials have similar 3-D structures; the voids between the agglomerated particles result from the removal of the sacrificial support particle (˜30 nm for fumed silica). Larger voids in the material can be explained by the presence of agglomerates of SiO₂ in colloidal silica, with a size of about 100 nm. The BET surface area of prepared catalysts was close to 40 m² g⁻¹, which is noticeably high for unsupported catalysts. The TEM images of the different palladium-copper materials in FIGS. 17-19 clearly show that the particles for PdCu and Pd₃Cu are finely distributed in the form of open agglomerates that do not present extensive sign of coalescence (in other words, the crystallites touch each-other but remain separated in terms of crystalline lattice). The picture drastically changes in the case of PdCu₃, where the agglomerated nanoparticles appear coalesced into larger features, which is likely due to the high concentration of copper and linked to the Cu₂O oxide detected in XRD. Whatever this small bias, the well-developed 3D structure, high surface area, and fine particle size distribution of these samples demonstrate the benefits of the sacrificial support method.

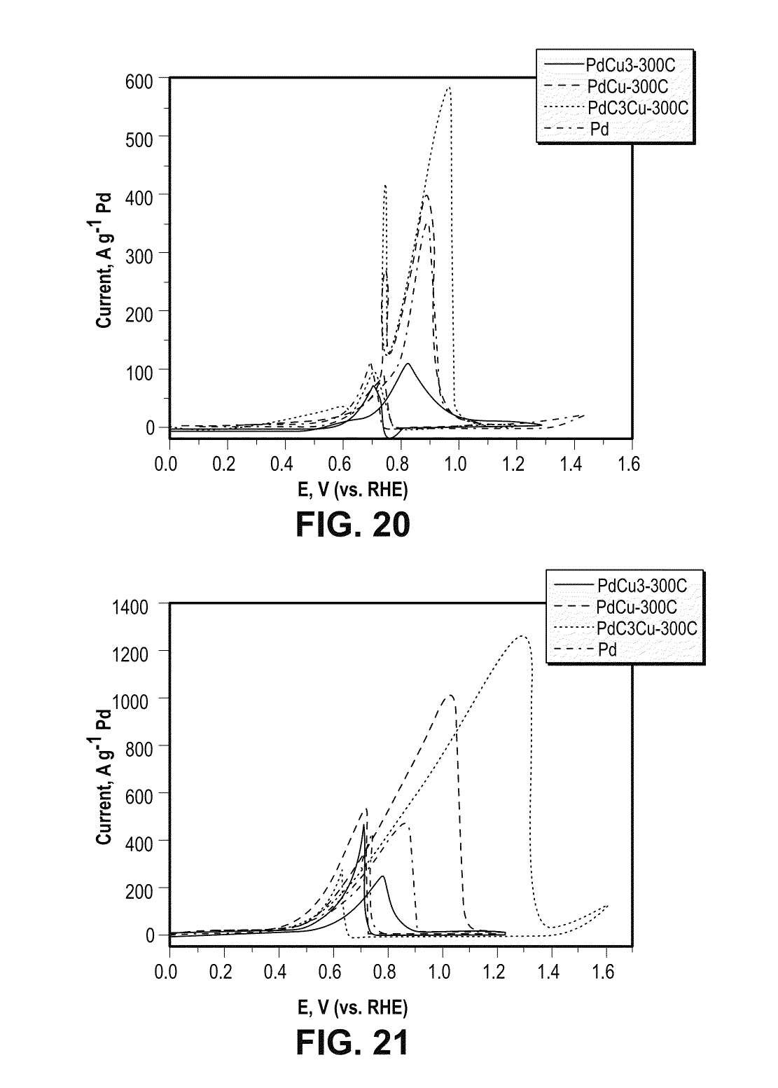

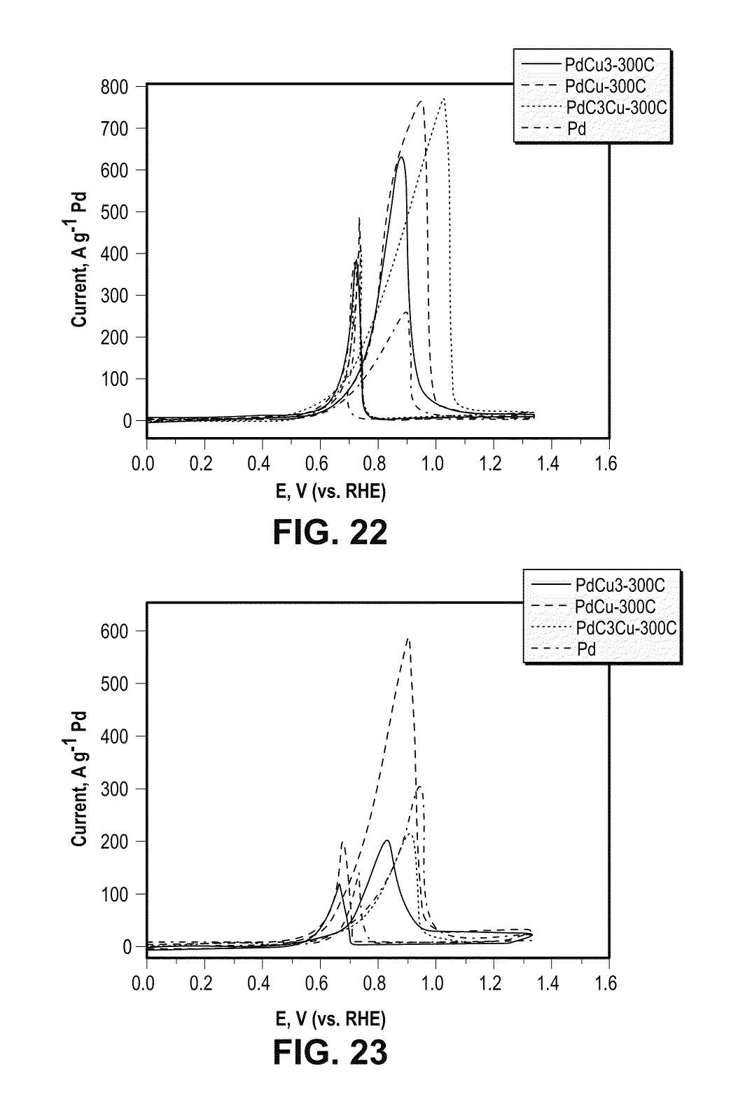

The analysis of the relative oxidative performance of various alcohols by PdₓCu_{y} emphasizes the commercial suitability of these catalysts; the currents are normalized to the mass of Pd, the most expensive element, while comparisons of kinetic limitations and oxidation onsets are evaluated by standard electrochemical criteria using current density. The electrochemical data for oxidation of alcohols on PdₓCu_{y} are presented in FIGS. 20-23 and Table 2.

TABLE 2

Tafel slopes/mV dec−1

| | | | Ethylene | |
|---|---|---|---|---|
| | Methanol | Ethanol | Glycol | Glycerol |
| Pd | 320 | 195 | 180 | 120 |
| Pd3Cu | 185 | 210 | 170 | 175 |
| PdCu | 150 | 220 | 185 | 175 |
| PdCu3 | 150 | 220 | 190 | 150 |

The Tafel slopes reported in Table 2 are apparent slopes; assumed is that non-linear contributions of diffusion were minor compared to dominant kinetic limitations, as observed in nearly linear Tafel slopes at even low potentials. For all alcohols except EG, the visible active phase is Pd—Cu, while the presence of Cu₂O decreases performance. PdCu₃, which contains a Cu₂O phase, presents extremely low performance, even after Pd mass normalization. However, PdCu₃ presents increased performances compared to Pd for EG (FIG. 3A), implying that Cu₂O may have a catalytic impact for EGOR. Economically, Pd₃Cu shows the highest performance towards EtOH oxidation reaction (EOR) and MeOH oxidation reaction (MOR) followed by PdCu and Pd (FIGS. 3A and 3B). Comparing the peak currents and onsets of Pd₃Cu and Pd, 570 A g_{Pd}⁻¹ vs. 110 A g_{Pd}⁻¹ for methanol and 1290 A g_{Pd}⁻¹ vs. 250 A g_{Pd}⁻¹ for ethanol, respectively, confirms that the Pd—Cu solid solution presents improved active sites as compared to Pd, since these samples have comparable BET surface areas (ca. 40 m² g⁻¹).

This assumption is further supported by the similar Tafel slopes, for EGOR and EOR, displayed by Pd₃Cu and Pd, indicating that the improvement is not on kinetics but mostly on total electrochemically active surface area (ECSA). On the contrary, the low potential currents of MOR on the Pd—Cu solid solution exhibits visibly improved kinetic as compared to Pd: 150-185 mV dec⁻¹ vs. 320 mV dec⁻¹, as shown in Table 2. This indicates that the increased performance towards MOR is not only due to increased ECSA, and can be directly attributed to the presence of a Pd—Cu solid solution, especially considering the low performance of PdCu₃ (which contains proportionally less Pd—Cu due to the presence of Cu₂O). By opposition, GOR presents lower Tafel slopes for Pd, indicating that Pd—Cu solid solution may induce a kinetics decreasing. The slight improvement in onset potentials (Table 3) observed for all alcohols, except EG, implies that the addition Cu to Pd leads to modifications in chemisorption properties, which could specifically affect the adsorption potential of reactants. Pd₃Cu exhibits the lowest onset potentials for MOR and EOR (Table 3), while PdCu exhibits the lowest onset potentials for glycerol, EtOH and EG oxidation (Table 3).

TABLE 3
Onset potentials in mV for Pd and Pd_{X}Cu_{y} catalysts in different alcohols.

| | Methanol | Ethanol | Glycerol | Ethylene Glycol |
|---|---|---|---|---|
| Pd | −575 mV | −580 mV | −350 mV | −490 mV |
| Pd3Cu | −580 mV | −600 mV | −465 mV | −480 mV |
| PdCu | −415 mV | −600 mV | −510 mV | −485 mV |
| PdCu3 | −290 mV | −531 mV | −340 mV | −480 mV |

In order to gain a better insight into the system on the molecular level, we used Density Functional Theory (DFT) with the Perdew-Burke-Ernzerhof (PBE) functional^{[35,36]} to study the adsorption of EtOH and OH species on Pd(111) and Pd₃Cu(111) surfaces. (See J. P. Perdew, K. Burke and M. Ernzerhof, Phys. Rev. Lett, 77, 3865 (1996) and J. P. Perdew, K. Burke and M. Ernzerhof, Phys. Rev. Lett, 78, 1396 (1997).) EtOH was studied since it presented the best electrochemical performances—highest peak, best onset—that make it suitable for economical applications.

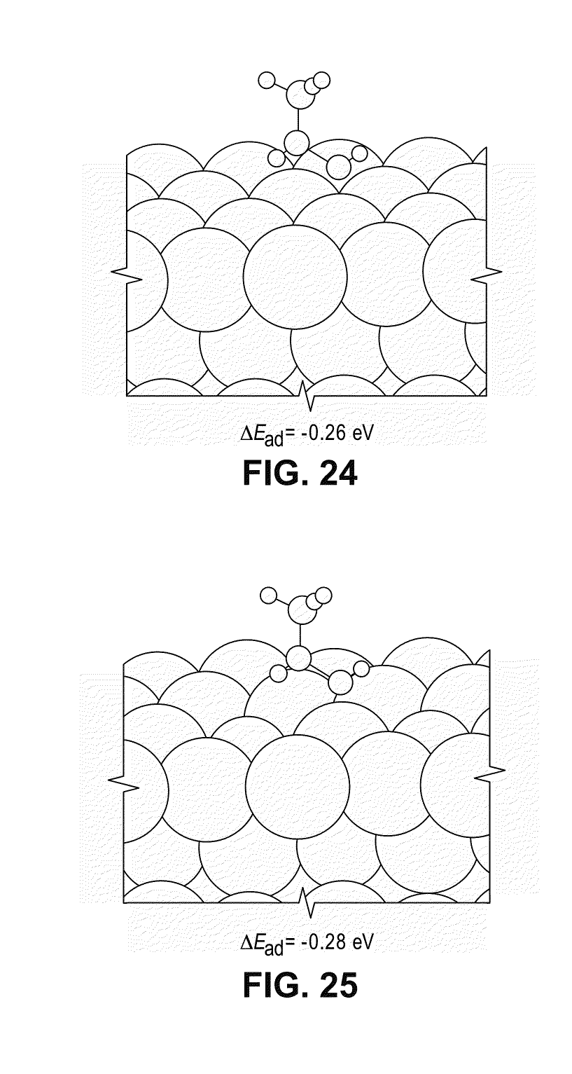

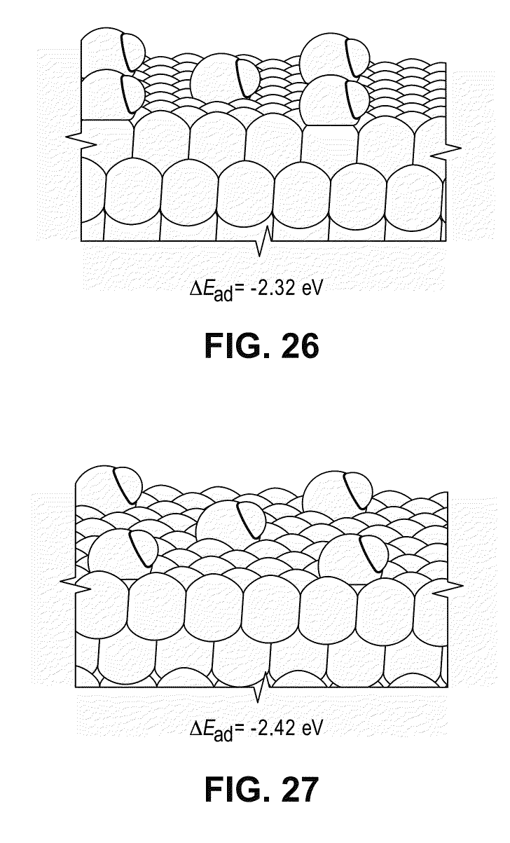

As seen from FIGS. 24-27 EtOH interacts very weakly with both surfaces. The adsorption energy of EOH on Pd(111) and Pd₃Cu(111) surfaces is calculated as −0.26 eV and −0.28 eV, respectively. Considering the fact that the entropy loss associated with the adsorption of EtOH from water solution is +0.50 eV at 298 K, adsorption of EtOH would be thermodynamically unfavourable as the change in electronic energy associated with the adsorption will not compensate for the loss in entropy. However, the samples synthesized using SSM are highly nanostructured and due to the confinement of EtOH in the material pores, entopic losses associated with the adsorption are much smaller, which decreases the adsorption potential of EtOH.

Thus we can argue that the SSM method improves the catalytic activity, not just by increasing the total electrochemically active surface area, but also decreasing the Gibbs free energy for the adsorption of reactants. This effect is especially important for the adsorption of species that interact with the catalytic surface by weak dispersion forces, such as interaction of EtOH with Pd and Pd₃Cu.

OH chemisorbs on the surface of Pd and Pd₃Cu and the adsorption energy of OH species is calculated as −2.32 eV on top of Pd atoms of the Pd(111) surface, −2.31 eV on top of Pd atoms of the Pd₃Cu(111) surface and −2.42 eV on top of Cu atoms of the Pd₃Cu(111) surface. If we assume that all the other contributions to the Gibbs free energy of adsorption will not differ significantly on these two surfaces, the calculated adsorption energies show that the adsorption potential of OH on Pd₃Cu(111) surface is for 100 mV smaller than on Pd(111) surface. The presence of OH species on the surface of the Pd₃Cu catalyst at lower cell potentials will be beneficial for the overall mechanism of alcohol adsorption, since those species are involved in various step of the EOR. Thus, their presence and easier adsorption are implying a lager turnover of the catalytic sites. These results can also explain lower activity of PdCu₃ for EtOH oxidation as compared to Pd and Pd₃Cu. Higher the concentration of Cu atoms on the surface, OH coverage on the surface will be higher even at lower cell potentials, which will decrease the number of metal sites available to catalyse the oxidation of alcohols.

In the case of EG, all Pd—Cu catalysts exhibit similar kinetics and increased performances, in terms of both maximum current, notably peak currents of 260 A g_{Pd}⁻¹ for Pd vs. 630 A g_{Pd}⁻¹ for PdCu₃ (FIG. 3C) which is a marked improvement when compared with other alcohols. An explanation for this behaviour may be due to a catalytic contribution from Cu₂O towards ethylene glycol oxidation, combined with the previously noted contributions from Pd—Cu, specifically an improved onset potential and increased ECSA. Finally, it is interesting to note that although the addition of Cu affects the direct scan (FIG. 3), it does not affect the adsorption potential of the reverse scan, which is observed to be similar value (ca. 0.7 V vs. RHE) for nearly all catalysts and fuels, suggesting that Cu adjunction to Pd does not impact on the desorption potential of OH_{ads}.

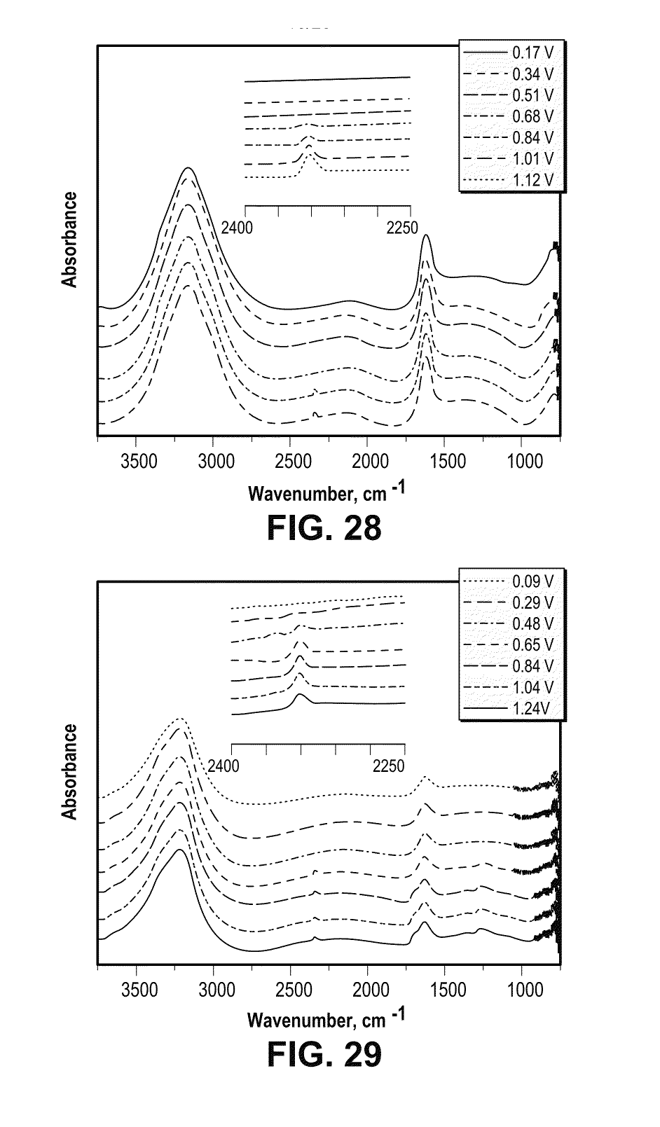

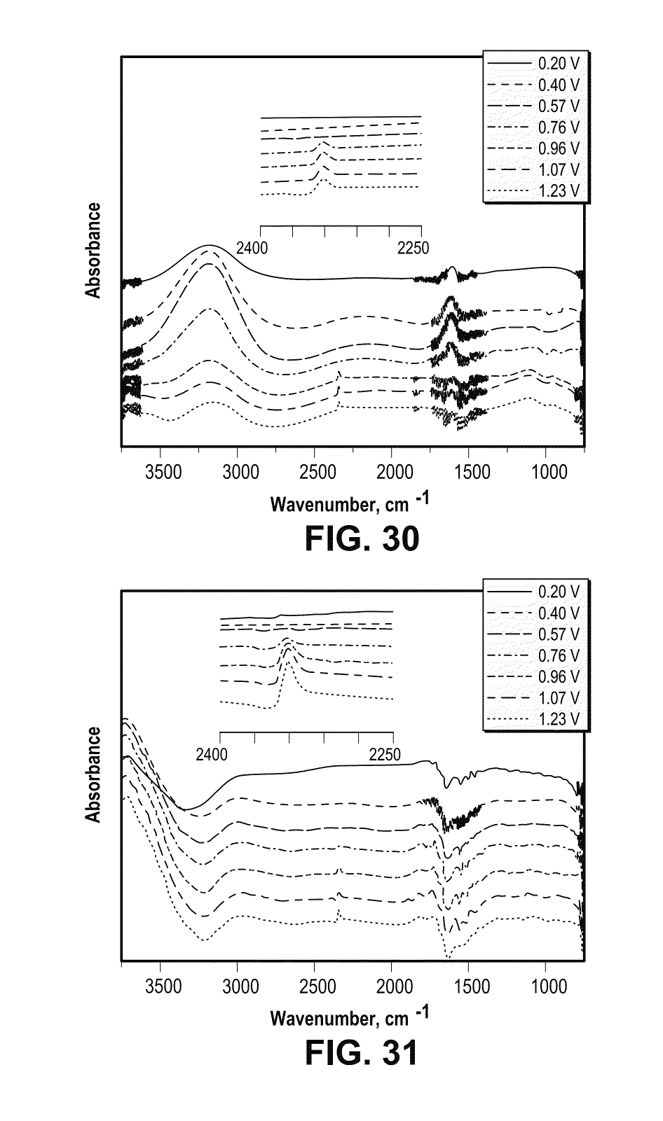

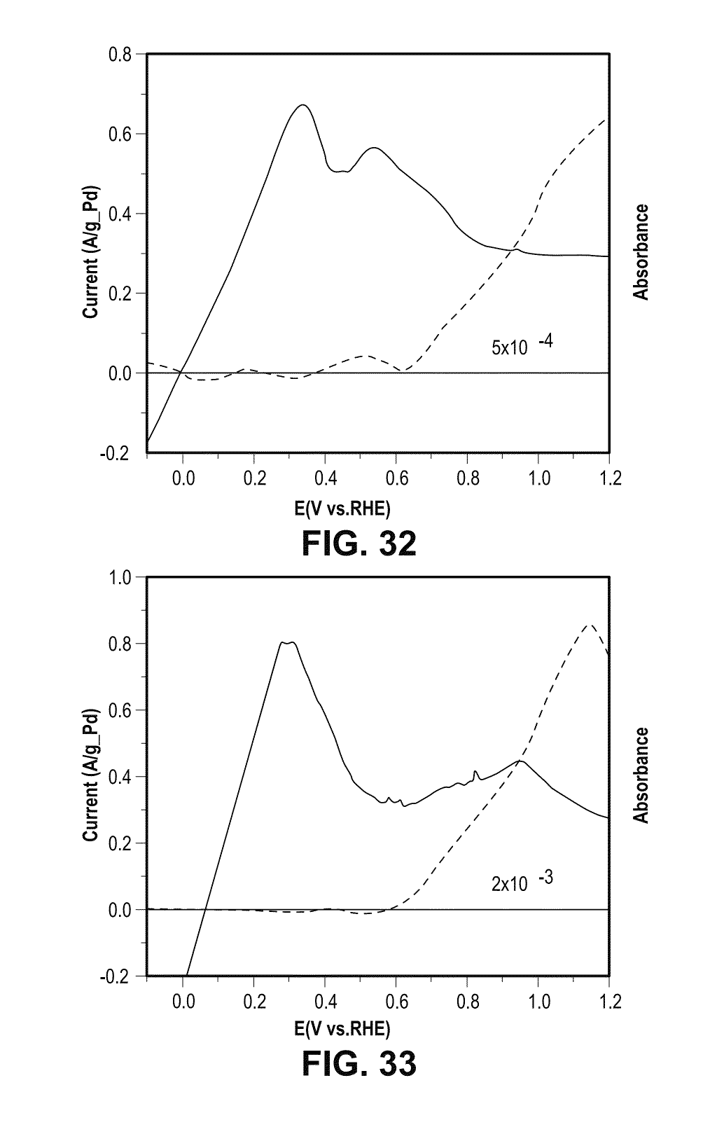

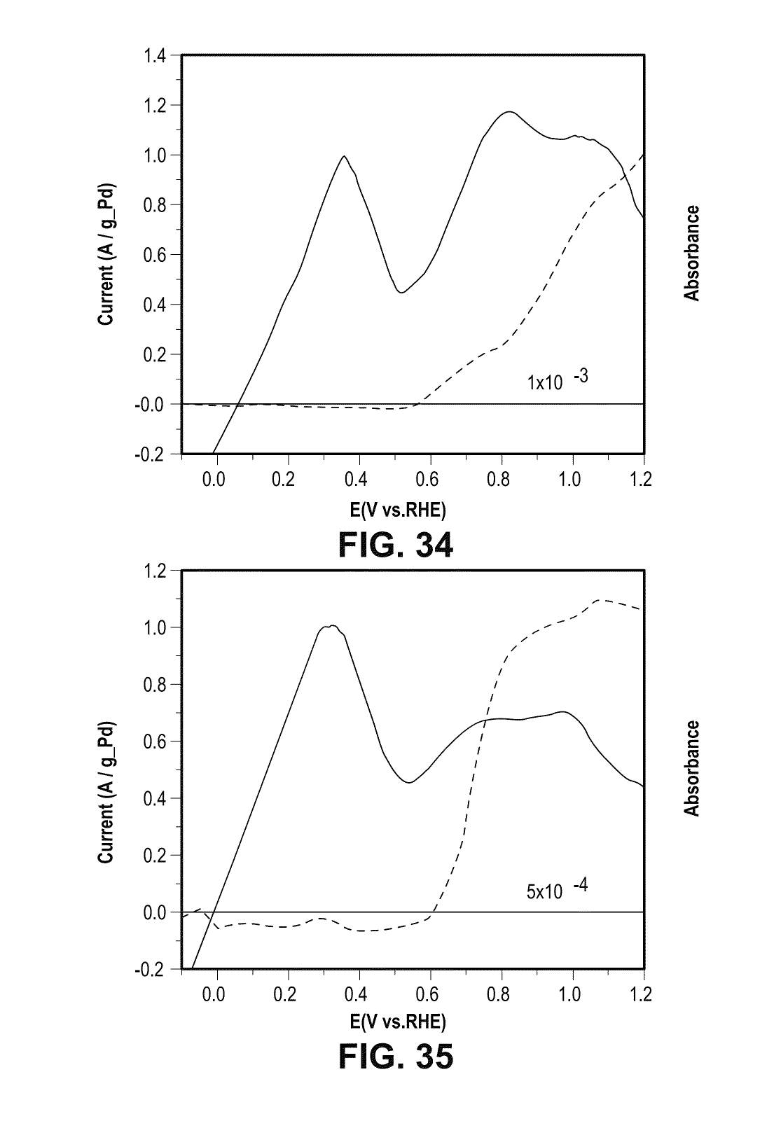

Detailed FTIR studies are presented in FIG. 28-31. To correlate them with currents and electrochemical results, measurements were carried out in the same cell as the one used for FTIR, as presented in FIG. 32-35.

The dissemblance with FIG. 20-23 results can be explained by the scan rate variation, showing that alcohol and —OH adsorption are not only limited by thermodynamic phenomenon but also by kinetics phenomenon. Indeed, in steady state condition, characterized by an extremely slow scan rate (v=1 mV s⁻¹) the time given to a potential step is longer than in FIG. 20-23 condition. Species adsorption begins at similar potentials for all alcohols, ca.+0.2 V vs. RHE, The absorption of —OH is confirmed by the observation of a peak at 3150-3250 cm⁻¹. The first alcohol oxidation steps occur at the same potential, observed by the appearance of peaks at 1600-1650 cm⁻¹, corresponding to carbonyl species for EOR and the ethylene glycol oxidation reaction (EGOR) and an O—C—O bond for MOR and the glycerol oxidation reaction (GOR)—a slight effect of H—O—H bond can also be ascribed to those wavelengths. At this potential, only partial oxidation appears to occur for EOR, as showed by presence of acetate and acetaldehyde (Table 4). Note that acetate species are in solution at higher potentials, i.e. 0.65 V vs. RHE, as shown by the peak at 1280 cm⁻¹ a known marker of the presence of acetate in solution.^{[25-30]}The first steps of MOR occur at lower potentials, with total oxidation not observed until 0.68 V vs. RHE.

TABLE 4
Peak identification of chemical species by wavenumber for intermediates of different
alcohol oxided in situ on PdxCu (V vs. RHE)

| Wave- | | | | | |
|---|---|---|---|---|---|
| number | | | | | |
| (cm−1) | Methanol | Ethanol | EG | Glycerol | Functional Group |
| 1070-1100 | No | No | Yes; | Yes; | CO stretch of carboxylic, |
| | | | 0.40 V | 0.40 V | alcoholic or |
| | | | | | phenolic groups |
| 1280 | No | Yes; 0.65 V | No | No | CO Stretch |
| 1350-1380 | Yes; 0.65 V | Yes; 0.65 V | No | No | Carbonate Anions |
| | | | | | In-plane C—H stretch |
| 1550-1650 | Yes; All | Yes; All | Yes; | Yes; All | Carbonyl species (R2C = |
| | | | All | | O), OCO species, or |
| | | | | | HCOO |
| 2340 | Yes; 0.68 V | Yes; 0.48 V | Yes; | Yes; | Adsorbed CO2 |
| | | | 0.76 V | 0.76 V | |
| 3150-3250 | Yes; All | Yes; All | Yes; | Yes; All | OH Species |
| | | | All | | |

For GOR, according to M. Simoes, S. Baranton, C. Coutanceau, Appl. Catalysis B:Environ., 93 (2010) 354. and A. Zalineeva, A. Serov, M. Padilla, U. Martinez, K. Artyushkova, S. Baranton, C. Coutanceau, P. Atanassov, J. Am. Chem. Soc., 136 (2014) 3987, a peak at 1550-1650 cm⁻¹ signifies the presence of glycerate, while the peak at 1070-1100 cm⁻¹ indicates the presence of glyceraldehyde. Interestingly, glyceraldehyde formation is necessary in order to produce glycerate ion. It was assumed, consequently, that the 1550-1650 cm⁻¹ peak is also related to the reactant species adsorbed on the surface. For EGOR, since glycolate and glyoxylate are produced from glycoaldehyde oxidation, it was assumed that 1550-1650 cm⁻¹ peak can be attributed solely to glycoaldehyde, whereas the peak at 1070-1100 cm⁻¹ can be attributed to glycolate and glyoxylate. Total oxidation and C—C bond cleavage occurs on all catalysts, characterized by CO₂ peak appearance at 2340 cm⁻¹ at 0.48 V vs. RHE for EOR, 0.68 V vs. RHE for MOR, and 0.76 V vs. RHE for GOR and EGOR. However, partial oxidation still occurs for EOR, as shown by the continued presence of 1550-1650 cm⁻¹ peak, a partial oxidation species.

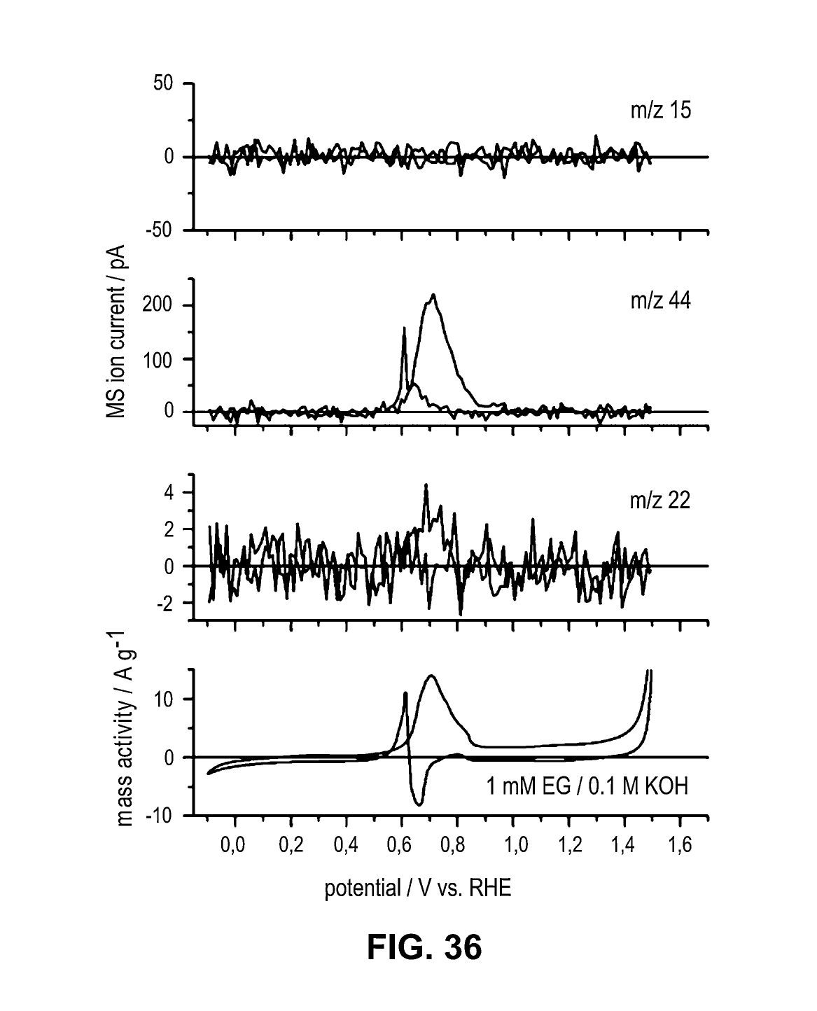

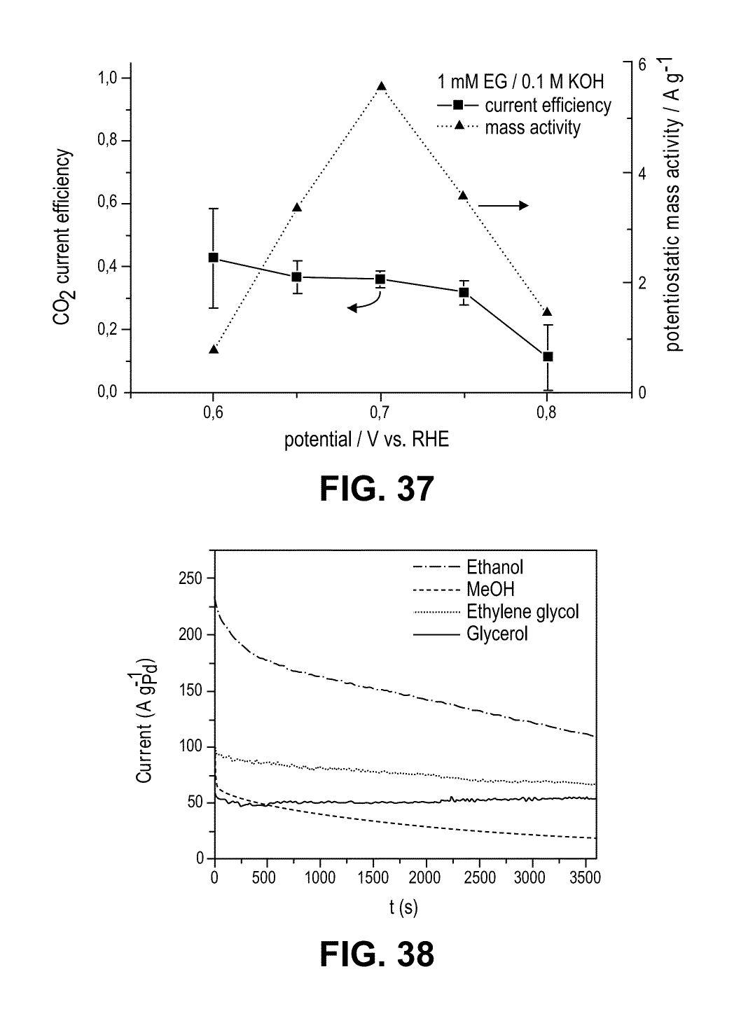

Additionally the CO₂ current efficiency (CCE) for the ethylene glycol oxidation at the PdCu catalyst was quantified by differential electrochemical mass spectrometry, based on the calibration of the m/z=22 and m/z=44 signals using CO-stripping voltammetry. Under potentiostatic conditions CCE around 40% were found in the potential range of 0.6 V to 0.7 V vs. RHE (FIGS. 36, 37). The MSCV shows the same onset potential of about 0.6 V vs. RHE as the FTIR data, the onset potential in DEMS being identical for both the m/z=22 (signature of CO₂) and m/z=44 (signature of CO₂ or a C₂H₄O⁺ fragment e.g. from acetaldehyde). However, as no increase of the m/z=15 signal is observed, which is also a fragment of acetaldehyde, this indicates that the m/z=44 not due to acetaldehyde. As the CO₂ CCE is only short to 40% the balance of the faradaic current must enter into the formation of non volatile species such as oxalate. Finally, the lack of m/z=15 signal close to the hydrogen evolution region (i) rules out any methane formation, as formerly found for palladium catalyst, (ii). At pure Pd only the CCE is marginal and some acetaldehyde is observed.

Chronoamperometry experiments were carried out on Pd₃Cu for the different alcohols (FIGS. 38).

Glycerol exhibits high stability over time. All other alcohols exhibit current decrease, which can be related to several phenomena including: slow desorption of acetate from the surface (EOR), poisoning of the active sites by CO or other intermediate species (all alcohols), or diffusion limitations- for example, the diffusion layer increasing—may all be related to the current diminution.

### Example III

### PdPb Materials

### Preparation of PdPb Materials

Pd—Pb catalysts were prepared by modified sacrificial support method as disclosed herein. First, a calculated amount of silica (Cab-O-Sil® EH5, surface area 380 m² g⁻¹) was dispersed in water in an ultrasound bath. Then, solution of palladium nitrate and led nitrate in water was added to silica and ultrasonicated for 20 minutes (the total Pd—Pb loading on silica was calculated as ˜15 wt. %). After ultrasonication colloidal solution of silica and Pd(NO₃)₂/Pb(NO₃)₂ was dried overnight at T=85° C. The obtained solid was ground to a fine powder in an agate mortar, and then subjected to thermal reduction (TR) in 7 at. % H₂ (flow rate 100 cc min⁻¹), 10 deg min⁻¹ temperature ramp rate, T=300° C. and t=1 hr. After reduction step, silica was leached by 7M KOH overnight. Finally, Pd—Pb materials were washed with DI water until neutral pH and dried at T=85° C. To compare activity of Pd-black, the synthesis was also performed with palladium nitrate only.

Discussion

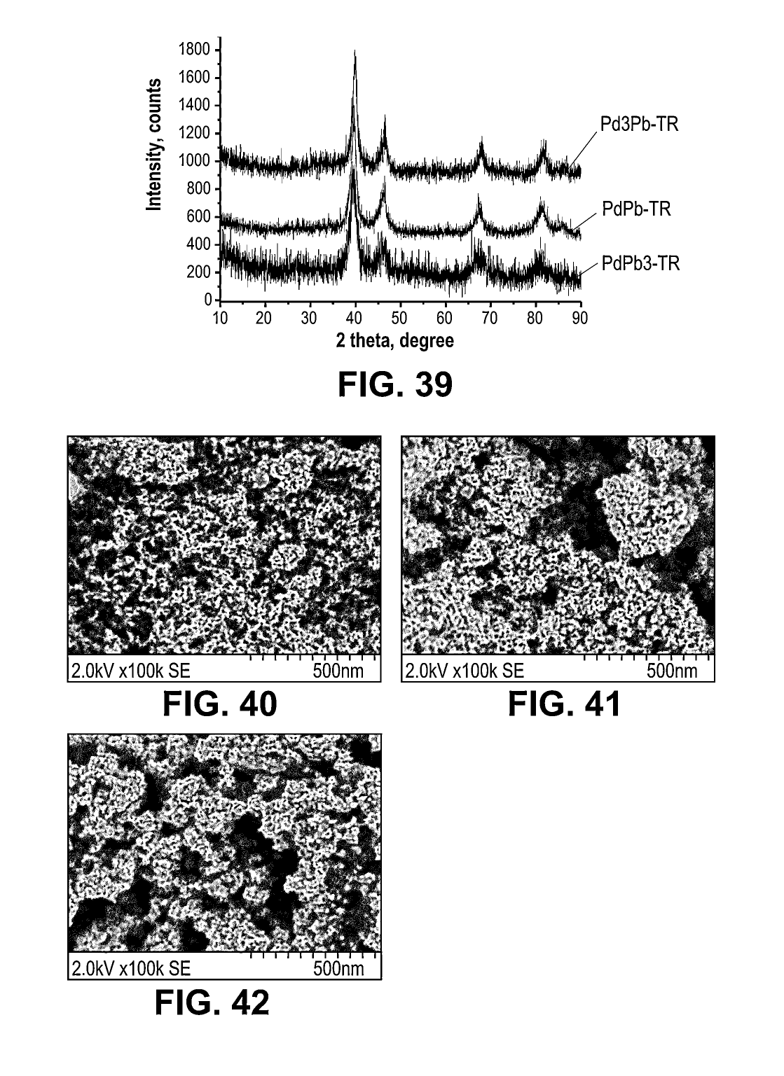

XRD diffractograms of Pd:Pb materials with ratio 1:3, 1:1 and 3:1 are shown on FIG. 39.

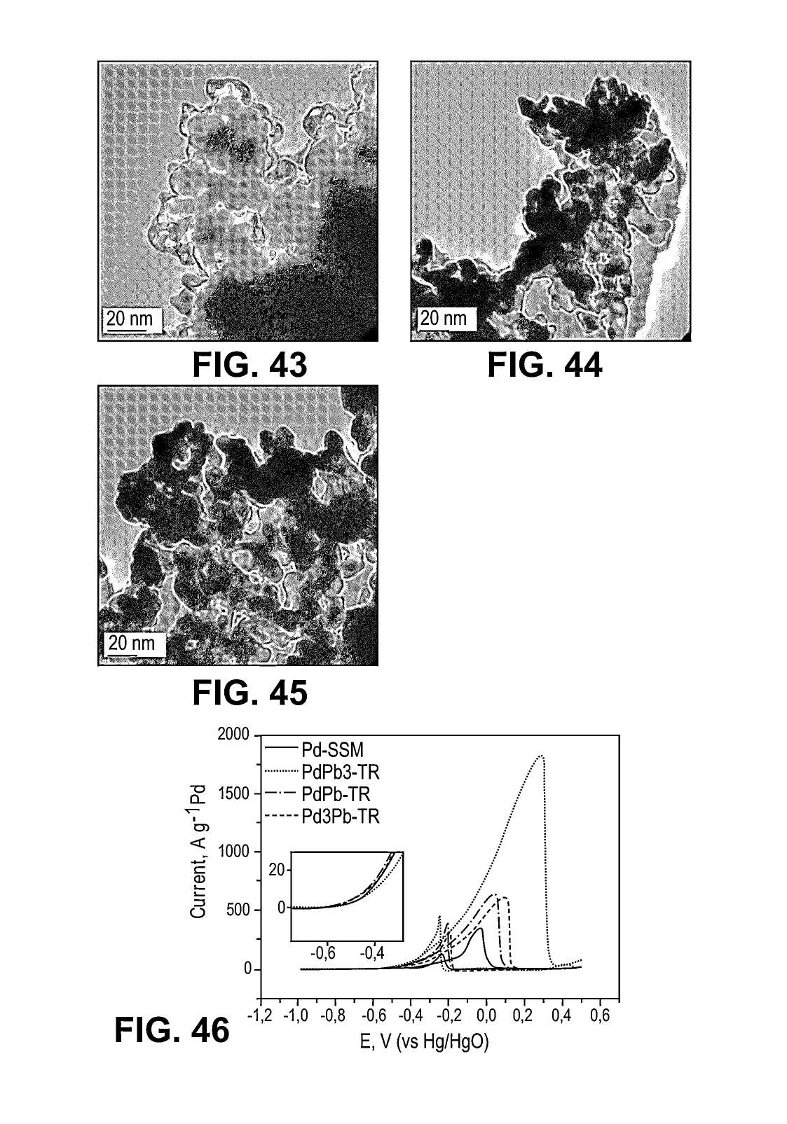

Analysis of the morphology of the materials by SEM imaging revealed that the material has a sponge-like structure formed after removal of the sacrificial support (FIGS. 40-45). The surface area of all three materials was comparable to one from state-of-the-art commercial PtRu electrocatalysts and was found to be 35-45 m² g⁻¹. TEM experiments confirmed the formation of a 3D porous matrix of Pd—Pb without significant agglomeration of particles (FIGS. 43-45).

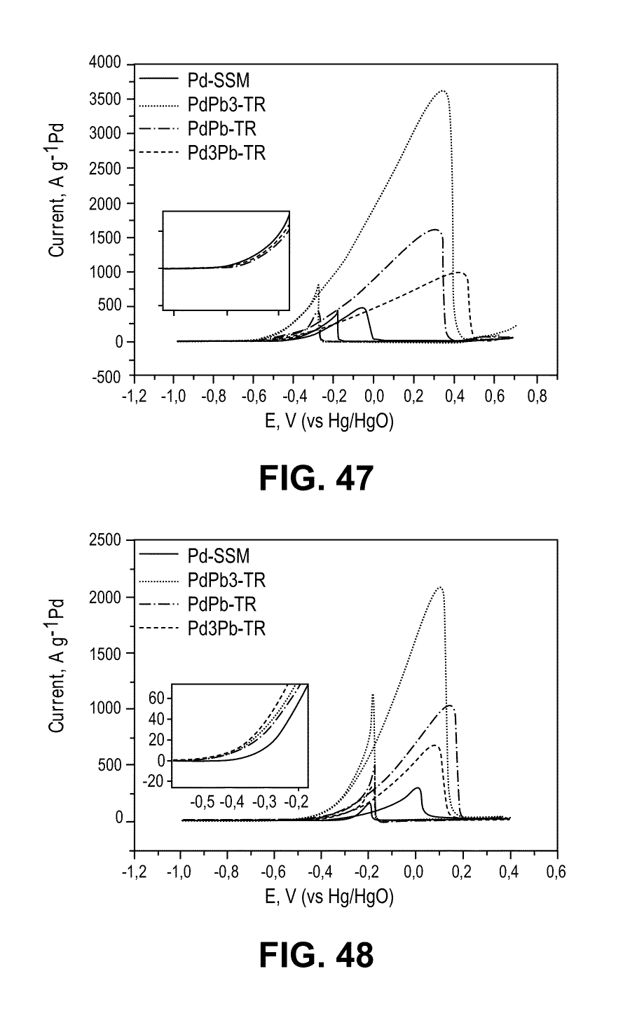

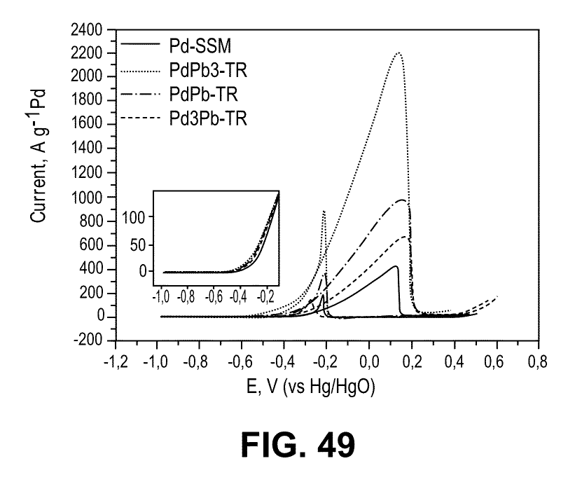

Pd—Pb electrochemical performances toward electroxidation of different alcohols, such as methanol (MOR), ethanol (EOR), ethylene glycol (EGOR), and glycerol (GOR) were studies. Analysis of the results was performed using two criteria: 1) economic performance, i.e. the normalization by the mass of Pd (FIGS. 46-49) and 2) electrochemical performance, i.e. the analysis of oxidation onsets and comparison of calculated Tafel slopes values (Table 5, Table 6). Tafel slopes were calculated in the kinetic limited regions (defined as close to the onset potential), and it was assumed that non-kinetics limitations, such as diffusion processes, were comparatively small. Consequently the Tafel slopes reported should be considered indicative values.

TABLE 5
Overpotential values of Pd—Pb and Pd catalysts prepared by thermal
reduction (V vs. Hg/HgO).

| | Methanol | Ethanol | Ethylene Glycol | Glycerol |
|---|---|---|---|---|
| Pd | −590 mV | −560 mV | −425 mV | −455 mV |
| Pd₃Pb | −605 mV | −560 mV | −595 mV | −550 mV |
| PdPb | −605 mV | −560 mV | −595 mV | −555 mV |
| PdPb₃ | −590 mV | −560 mV | −595 mV | −725 mV |

TABLE 6
Tafel slopes values of Pd—Pb and Pd catalysts prepared by thermal
reduction. Slopes are in mV per current decade, where the current is in
A · g⁻¹

| | Methanol | Ethanol | Ethylene Glycol | Glycerol |
|---|---|---|---|---|
| Pd | 290 mV/dec | 200 mV/dec | 150 mV/dec | 155 mV/dec |
| Pd₃Pb | 295 mV/dec | 220 mV/dec | 170 mV/dec | 185 mV/dec |
| PdPb | 290 mV/dec | 220 mV/dec | 170 mV/dec | 200 mV/dec |
| PdPb₃ | 310 mV/dec | 210 mV/dec | 165 mV/dec | 245 mV/dec |

Economic comparisons show that PdPb₃ exhibits the highest performance for oxidation of all alcohols. The improved performance of PdPb₃ per gram of Pd for electroxidation of all fuels is exhibited when comparing the peak currents for PdPb₃ and Pd, respectively: 1820 A g_{Pd}⁻¹ vs. 350 A g_{Pd}⁻¹ for methanol, 3600 A g_{Pd}⁻¹ vs. 500 A g_{Pd}⁻¹ for ethanol, 2080 A g_{Pd}⁻¹ vs. 300 A g_{Pd}⁻¹ for ethylene glycol and 2200 A g_{Pd}⁻¹ vs. 420 A g_{Pd}⁻¹ for glycerol. However, electrochemical analysis indicates that Pd is responsible for improved kinetics, as shown by Tafel slopes presented in Table 6 (reported as mV dec⁻¹, where the decade is in A.g⁻¹). The slopes are inversely proportional to the number of electrons exchanged during the rate determining step (RDS) and the geometric coefficient α. Comparison of Tafel slope for GOR clearly shows the Pd catalytic properties; unalloyed Pd presents a slope of 155 mV dec⁻¹, while addition of Pb leads to a decreasing kinetics, proportional to the added amount of Pb. The effect of Pb is similar for the other fuels. Although kinetic performance is observed to decrease with the addition of Pb, there appears to be an improvement for the adsorption affinity of reactant species, as characterized by a decreased onset potential (Table 7). Once again, this behavior is very clear for GOR, where the onset decreases with increasing Pd catalyst content. There is little difference between the onsets for C₁ and C2 alcohols (methanol and ethanol). Finally, all catalysts present nearly the same behaviors toward OH_{ads} desorption during the reverse scan, observed at 0.2 V vs. Hg/HgO for all alcohols, except for ethanol, which shows desorption at ca. 0 V vs. Hg/HgO on Pd—Pb, implying that Pb adjunction does not impact on the OH⁻ competitive adsorption on the catalyst surface.

TABLE 7
FTIR wavelengths and peaks/trough/species associated
for PdPb₃ for different alcohols.

| Wavenumber | Meth- | Eth- | | Glyc- | Associated species |
|---|---|---|---|---|---|
| (cm⁻¹) | anol | anol | EG | erol | and bonds. |
| 1010 | Y | | | | Methanol. |
| 1040-1050 | | Y | Y | Y | Ethanol, glycolate. |
| 1080 | | Y | Y | | Ethanol, glycolate. |
| 1100 | | | | Y | CO stretching of alcohol. |
| 1240 | | | Y | | Oxalate. |
| 1280 | | Y | | Y | CO stretching of acetate in |
| | | | | | solution. |
| 1370 | Y | | | | HCOO and CHO stretching. |
| 1620-1630 | Y | Y | Y | Y | C═O bond stretching - |
| | | | | | acetaldehyde, acetate, |
| | | | | | glycoaldehyde, etc . . . - |
| | | | | | or OCO bonds - HCOO. |
| 2340 | Y | Y | Y | Y | CO₂(ads) |
| 3150-3300 | Y | Y | Y | Y | OH— alcohol stretching. |

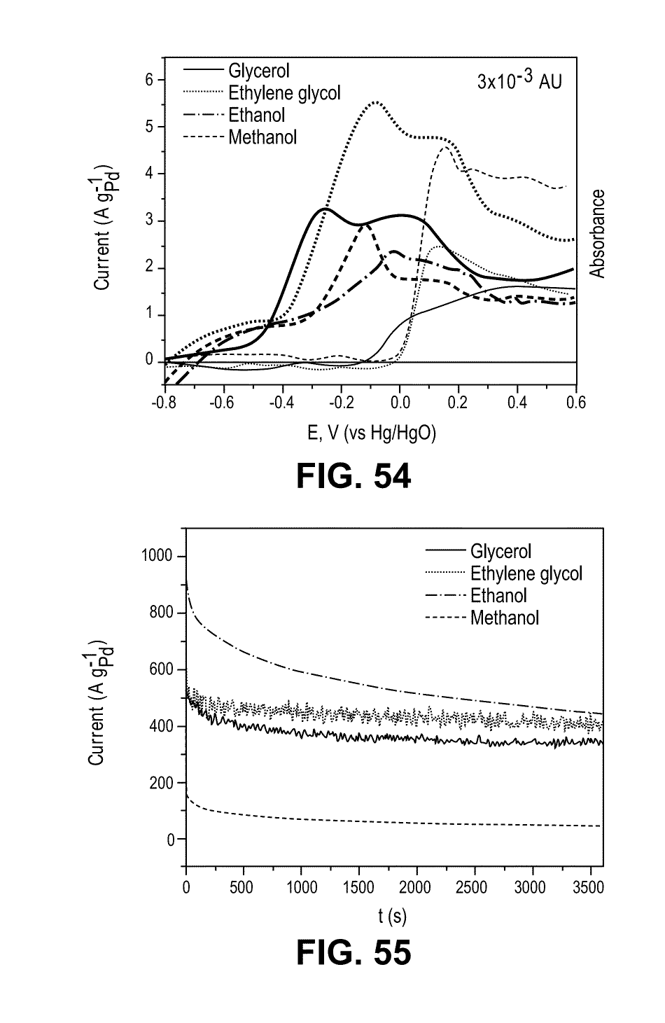

The possible mechanisms of oxidation for the most interesting catalyst, PdPb₃, were investigated via in situ FTIR analysis for all alcohols. Observed differences between the linear voltammetry measurements in FTIR (FIG. 54) and cyclic voltammogramms presented in FIGS. 46-49 can be attributed to different scan rates (1 mV s⁻¹ vs. 20 mV s⁻¹), cell geometry, and decreased electrolyte molarity (0.1M vs. 1M KOH).

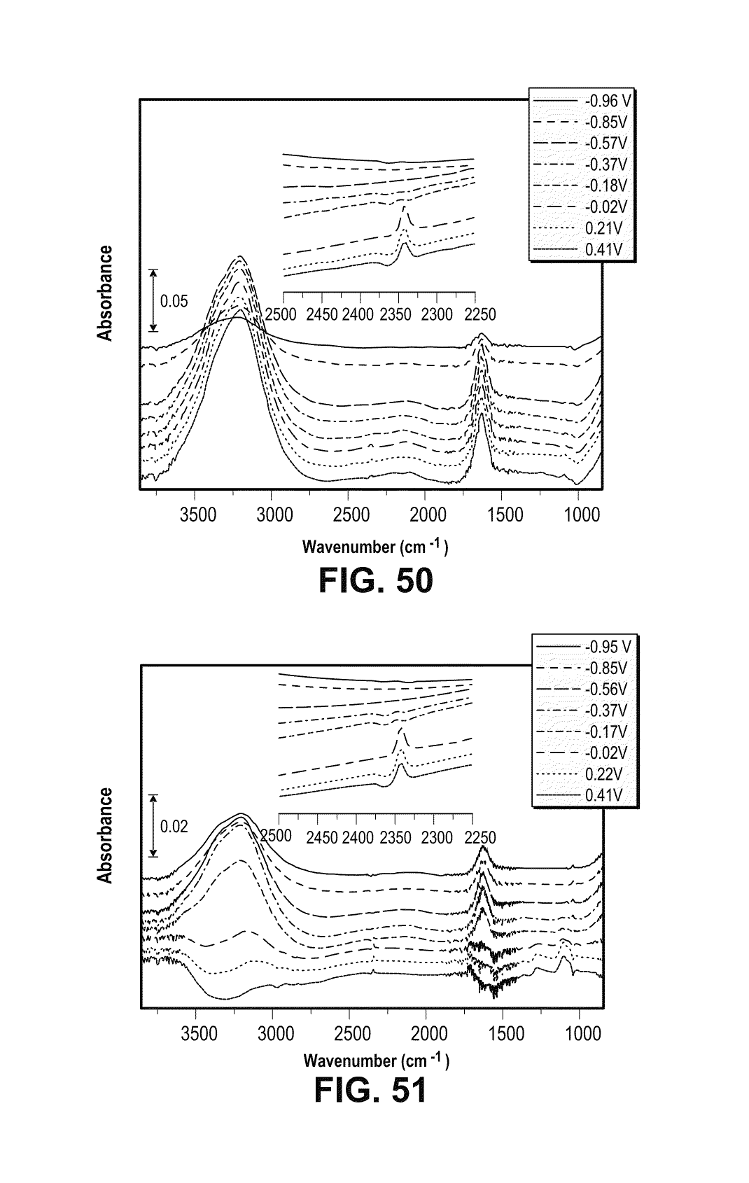

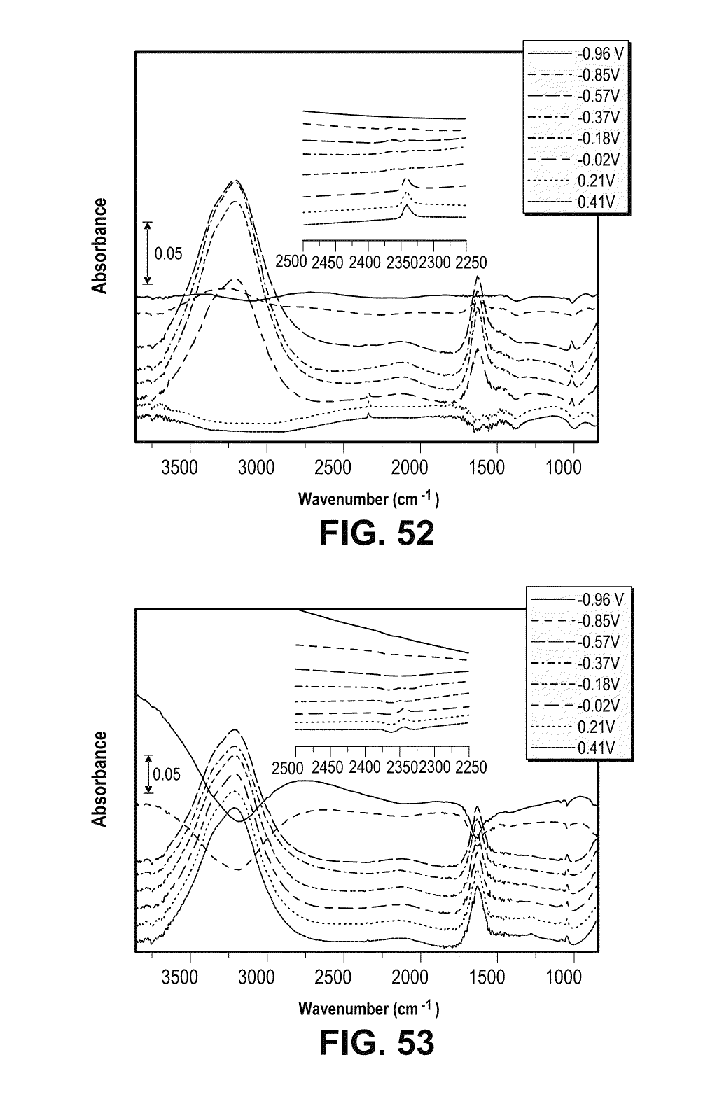

FIGS. 50-53 display spectrum collected during simultaneous linear voltammetry, with notable peaks observed during electrooxidation of fuels summarized in Table 7. Relevant wavenumbers for alcohols [1b-7b], those which signify adsorption and desorption (physical or chemical) on the catalyst surface by inducing a peak or trough appearance are observed at 3150-3300, 1040, 1050, 1100 and 1080 cm⁻¹ (Table 3). Except for ethanol (ca.—0.57 V vs. Hg/HgO), all alcohols adsorb on PdPb₃ at potentials lower than −0.8 V vs. Hg/HgO. This result corresponds to the onset values presented in Table 5, where the highest onset observed is for ethanol (−560 mV vs. Hg/HgO or lower All the fuels are completely oxidized, in different proportions, as characterized by the appearance of an asymmetric CO₂ peak at 2340 cm⁻¹ for potentials higher than 0 V vs. Hg/HgO for all alcohol except glycerol (−0.2 V vs. Hg/HgO). Reaction pathways for each fuel can be elucidated by identifying intermediate species as characterized by peaks reported in Table 7. For methanol, first oxidation step occurs at the same potential as the adsorption (−0.8 vs. Hg/HgO), indicated by the appearance of a peak at 1630 cm⁻¹ that is representative of the O—C—O bond stretching for CHO_{ads} and HCOO_{ads} intermediates [7b]. This peak can also be ascribed to the symmetric stretch of water, but its intensity variations correlate to methanol oxidation peaks (FIG. 54), implying that it is representative for MOR involved species. Interestingly, the peaks associated with methanol and intermediate species disappear at potentials higher than 0.02 V vs. Hg/HgO, whereas trough appears at 1010, 1370, 1600-1650 and 3150-3300 cm⁻¹ that indicate methanol and intermediate species desorption/consumption. This is also observed for glycerol, implying that this phenomena is not intrinsically related to the alcohol and can be attributed to several possible effects: 1) The surface potential is too high for the stable adsorption of neutral species (not observed for ethylene glycol or ethanol) or 2) Consumption of reactant species occurs rapidly, inducing short adsorption time and diffusion limitations—an effect which also explains the continued increase of CO₂ peaks at positive potentials (0 to 0.4 V vs. Hg/HgO).

For ethanol, the partial oxidation, i.e. the pathway that will lead to acetaldehyde and acetate products, begins at −0.6 V vs. Hg/HgO, as shown by the appearance of a peak at 1630 cm⁻¹. Total oxidation only occurs in extremely small proportion on PdPb₃ for EOR, as showed by the low intensity of the 2340 cm⁻¹ peak. Furthermore, if acetate and acetaldehyde are produced starting at −0.6 V vs. Hg/HgO, acetate desorbs from the surface only at positive potentials, as shown by the 1280 cm⁻¹ band that is characteristic for “in solution” acetate [2b-6b; 8b-10b]. Consequently, those species may poison the surface at low potentials during potentiostatic experiments. For ethylene glycol, oxidation occurs thru several steps, which includes the formation of the intermediates glycoaldehyde, glycolate, glyoxylate, and oxalate [11b]. The peak at 1630 cm⁻¹ can be attributed to the C═O bond stretch of glycoaldehyde, glycolate, and glyoxylate species. Glycolate and glyoxylate peaks appear at 1045 cm⁻¹ and 1080 cm⁻¹, starting at −0.6 V vs. Hg/HgO, whereas the peak at 1630 cm⁻¹ appears at −1.0 V vs. Hg/HgO. Consequently, it is assumed that glycoaldehyde oxidation only occurs after −0.6 V vs. Hg/HgO and its products (glycolate and glyoxylate) oxidize to oxalate species at more positive potentials, represented at these potentials by the appearance of a shoulder at 1240 cm⁻¹. CO₂ formation occurs at the same potential (0 V vs. Hg/HgO), implying that oxalate can be oxidized to CO₂ at its formation potential. Lastly, glycerol oxidation intermediate species, such as the peak attributed to the COO⁻ stretching of a glycerate ion [12b] at 1575 cm⁻¹, are obscured by the peak at 1620-1630 cm⁻¹ which may be representative of glycerol adsorption in this specific case. Increased kinetics phenomena at high potentials produced a trough that was observed at this wavenumber, indicating that the glycerate ion was adsorbed on the surface at lower potentials. This identification is also confirmed by a small amount of CO₂ production, with a peak at 2340 cm⁻¹ appearing at −0.2 V vs. Hg/HgO.

FIG. 55 shows the potentiostatic behaviors of PdPb₃ catalysts toward alcohol. The methanol low performances may be explained by the fact that CO₂ formation is not reached at such potentials, as showed by Table 3. Consequently, CO_{ads} and HCOO_{ads} species remains on the surface. Even if ethanol performances are interesting, the current decreasing with time, related to surface poisoning by the adsorbed partial oxidation products, appears as a drawback for this catalyst. Glycerol and ethylene glycol currents are stable with time and, if their initial performances are lower than the one observed for ethanol, they reach similar values at 3500 s.

What is claimed is:

1. A self-supporting porous material consisting of an alloy of at least two metals and a plurality of voids.

2. The self-supporting porous material of claim 1 wherein at least one of the metals is palladium.

3. The self-supporting porous material of claim 2 wherein at least one of the metals is selected from the group consisting of Co, Ni, Mn, Fe, Ag, Au, Pt, Rh, Ir, V, Cr, Cu, Bi, and Pb.

4. The self-supporting porous material of claim 2 wherein at least of the metals is selected from the group consisting of copper, bismuth, and lead.

5. The self-supporting porous material of claim 1 wherein at least some of the voids mimic the external shape of spherical particles.

6. The self-supporting porous material of claim 1 formed by:
mixing a sacrificial template and precursors of the at least two metals to form a silica-metal precursor composite;
reducing the metal precursors to form an alloy between the two metals;
removing the sacrificial template to produce a self-supporting porous material comprising an alloy of the at least two metals and a plurality of voids that exist where the sacrificial template had previously resided.

7. A self-supporting porous material comprising an alloy of at least two metals and a plurality of voids.

8. The self-supporting porous material of claim 7 wherein at least one of the metals is palladium.

9. The self-supporting porous material of claim 8 wherein at least one of the metals is selected from the group consisting of Co, Ni, Mn, Fe, Ag, Au, Pt, Rh, Ir, V, Cr, Cu, Bi, and Pb.

10. A method for forming a self-supporting porous material comprising an alloy of at least two metals and a plurality of voids, the method comprising:
mixing a sacrificial template and precursors of the at least two metals to form a silica-metal precursor composite;
reducing the metal precursors to form an alloy between the two metals;
removing the sacrificial template to produce a self-supporting porous material comprising an alloy of the at least two metals and a plurality of voids that exist where the sacrificial template had previously resided.

11. The method of claim 10 wherein the sacrificial template consists of a plurality of sacrificial particles.

12. The method of claim 10 wherein the sacrificial template comprises a plurality of sacrificial particles.

13. The method of claim 12 wherein the sacrificial particles are formed from silica.

14. The method of claim 13 wherein the step or removing the sacrificial template comprises chemical etching.

15. The method of claim 10 wherein at least one of the metal precursors is a palladium precursor.

16. The method of claim 15 wherein at least one of the metal precursors is selected from the group consisting of Co, Ni, Mn, Fe, Ag, Au, Pt, Rh, Ir, V, Cr, Cu, Bi, and Pb.

17. The method of claim 15 wherein at least one of the metal precursors is selected from the group consisting of precursors of copper, bismuth, and lead.

18. The method of claim 10 wherein the step of reducing comprises thermal reduction.

19. The method of claim 10 wherein the step of reducing comprises chemical reduction.

20. The method of claim 10 further comprising chemically etching at least one of the metals in the alloy.
